(19) United States
(12) Patent Application Publication
(10) Pub. No.: US 2014/0026228 A1
(43) Pub. Date: Jan. 23, 2014

(54) INFORMATION PROCESSING APPARATUS AND CONTROL METHOD

(71) Applicant: KABUSHIKI KAISHA TOSHIBA, Tokyo (JP)

(72) Inventors: Hiroshi Isozaki, Kawasaki-shi (JP); Ryuiti Koike, Kawasaki-shi (JP); Jun Kanai, Fuchu-shi (JP); Tatsuo Yamaguchi, Kunitachi-shi (JP); Yuki Kanbe, Ome-shi (JP); Jun Ohashi, Ome-shi (JP); Satoshi Ozaki, Hamura-shi (JP)

(73) Assignee: KABUSHIKI KAISHA TOSHIBA, Tokyo (JP)

(21) Appl. No.: 13/975,597

(22) Filed: Aug. 26, 2013

Related U.S. Application Data
(63) Continuation of application No. PCT/JP2013/057932, filed on Mar. 13, 2013.

(30) Foreign Application Priority Data
Jul. 23, 2012 (JP) 2012-162974

(51) Int. Cl. G06F 21/50

(52) U.S. Cl. CPC G06F 21/50
USPC 726/27

(57) ABSTRACT

According to one embodiment, an information processing apparatus includes a management module and a control module. The control module detects an event of requesting install of an application program, and transmits, prior to execution of the install, install event information including an application name of the application program to the management module. The management module notifies the install event information to a determination program, and transmits to the control module a determination result indicative of permission or prohibition of the install, the determination result being received from the determination program.

### CROSS REFERENCE TO RELATED APPLICATIONS

This application is a Continuation application of PCT Application No. PCT/JP2013/057932, filed Mar. 13, 2013 and based upon and claiming the benefit of priority from Japanese Patent Application No. 2012-162974, filed Jul. 23, 2012, the entire contents of all of which are incorporated herein by reference.

### FIELD

Embodiments described herein relate generally to an information process apparatus and a control method for restricting install of an application program.

### BACKGROUND

In recent years, in companies, attention has been paid to bringing a personally owned information terminal or the like in a company and using it for business work (so-called Bring Your Own Device (BYOD)). As the information terminal, use can be made of various information processing apparatuses such as a tablet terminal or a smartphone.

In order to realize BYOD, it is necessary to apply various security measures to the information processing apparatus.

As one of security techniques, a technique of restricting install of an application program by using a user permission level is used in personal computers, etc. In this case, the act of installing an application program is permitted to only a personal having a specific permission level, such as an administrator.

In addition, there is known a technique of determining the presence/absence of falsification of an application program, and prohibiting install of a falsified application program.

In the meantime, the kind of application program used in business work varies from company to company. Thus, in some cases, the content of install restriction or uninstall restriction, which is to be applied, varies from company to company.

Therefore, when an information processing apparatus is used in business work, it is necessary to realize a function for flexibly controlling the content of the install restriction or uninstall restriction for individual application programs.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a configuration of an information processing apparatus according to an embodiment.

FIG. 2 is an exemplary view illustrating a structure of an application package file which is used in the information processing apparatus of the embodiment.

FIG. 3 is an exemplary block diagram illustrating configurations of an access detection/control module and an application execution module, which are provided in the information processing apparatus of the embodiment.

FIG. 4 is an exemplary block diagram illustrating a configuration of a determination application module which is used in the information processing apparatus of the embodiment.

FIG. 5 is an exemplary block diagram illustrating a configuration of a management application module including a determination application registration module, which is provided in the information processing apparatus of the embodiment.

FIG. 6 is an exemplary flowchart illustrating the procedure of an install event process which is executed by the management application module of FIG. 5.

FIG. 7 is an exemplary flowchart illustrating a part of the procedure of a process which is executed by an installer module, access detection/control module, management application module and determination application module, which are provided in the information processing apparatus of the embodiment.

FIG. 8 is an exemplary flowchart illustrating the other part of the procedure of the process which is executed by the installer module, access detection/control module, management application module and determination application module, which are provided in the information processing apparatus of the embodiment.

FIG. 9 is an exemplary block diagram illustrating a configuration of the management application module including a default determination rule management module, which is provided in the information processing apparatus of the embodiment.

FIG. 10 is an exemplary flowchart illustrating the procedure of a process which is executed by the management application module of FIG. 9.

FIG. 11 is an exemplary block diagram illustrating a configuration of the management application module including an activate module, which is provided in the information processing apparatus of the embodiment.

FIG. 12 is an exemplary block diagram illustrating other configurations of the access detection/control module and application execution module, which are provided in the information processing apparatus of the embodiment.

FIG. 13 is an exemplary block diagram illustrating another configuration of the management application module, which is provided in the information processing apparatus of the embodiment.

FIG. 14 is an exemplary block diagram illustrating another configuration of the determination application module which is used in the information processing apparatus of the embodiment.

FIG. 15 is an exemplary flowchart illustrating the procedure of a determination application registration process which is executed by the management application module of FIG. 13.

FIG. 16 is an exemplary block diagram illustrating another configuration of the management application module which is provided in the information processing apparatus of the embodiment.

FIG. 17 is an exemplary block diagram illustrating another configuration of the access detection/control module, which is provided in the information processing apparatus of the embodiment.

FIG. 18 is an exemplary flowchart illustrating a part of another procedure of the process which is executed by the installer module, access detection/control module, management application module and determination application module, which are provided in the information processing apparatus of the embodiment.

FIG. 19 is an exemplary flowchart illustrating a portion of the other part of the another procedure of the process which is executed by the installer module, access detection/control module, management application module and determination application module, which are provided in the information processing apparatus of the embodiment.

FIG. 20 is an exemplary flowchart illustrating the other portion of the other part of the another procedure of the process which is executed by the installer module, access detection/control module, management application module and determination application module, which are provided in the information processing apparatus of the embodiment.

FIG. 21 is an exemplary block diagram illustrating still another configuration of the management application module, which is provided in the information processing apparatus of the embodiment.

FIG. 22 is an exemplary block diagram illustrating still another configuration of the determination application module, which is provided in the information processing apparatus of the embodiment.

FIG. 23 is an exemplary block diagram illustrating still another configuration of the determination application module, which is provided in the information processing apparatus of the embodiment.

FIG. 24 is an exemplary block diagram illustrating configurations of the access detection/control module including an uninstall event notification function and the application execution module including an uninstall request function, which are provided in the information processing apparatus of the embodiment.

FIG. 25 is an exemplary block diagram illustrating a configuration of the management application module including an uninstall determination function, which is provided in the information processing apparatus of the embodiment.

FIG. 26 is an exemplary block diagram illustrating another configuration of the management application module including the uninstall determination function, which is provided in the information processing apparatus of the embodiment.

FIG. 27 is an exemplary flowchart illustrating the procedure of an uninstall event process which is executed by the management application module in the information processing apparatus of the embodiment.

FIG. 28 is a block diagram illustrating a hardware configuration example of the information processing apparatus of the embodiment.

### DETAILED DESCRIPTION

Various embodiments will be described hereinafter with reference to the accompanying drawings.

In general, according to one embodiment, an information processing apparatus includes a management module and a control module. The management module is configured to provide an environment for install restriction of each of application programs. The control module is configured to detect an event of requesting install of an application program, and to transmit, prior to execution of the install, install event information including an application name of the application program to the management module. The management module notifies the install event information to a determination program, and transmits to the control module a determination result indicative of permission or prohibition of the install, the determination result being received from the determination program.

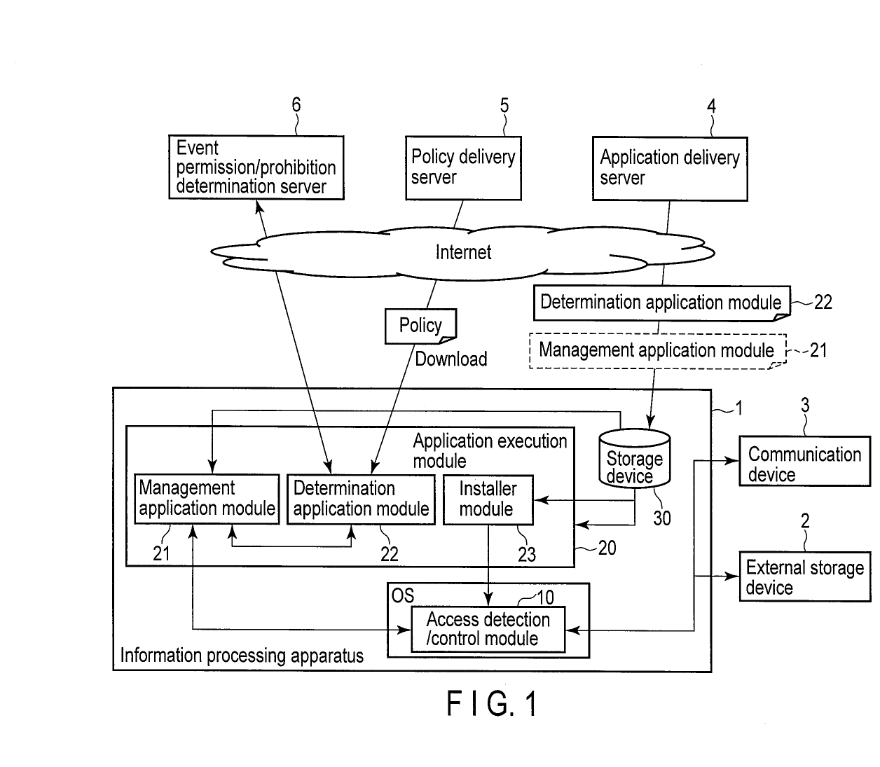

FIG. 1 shows the structure of an information processing apparatus 1 according to an embodiment. This information processing apparatus 1 is configured to execute various application programs, and can be realized by, for example, a tablet terminal, a smartphone, a PDA, or other various information terminals. The information processing apparatus 1 has a function of accessing an external storage device 2 such as a USB memory or an SD memory card. In addition, the information processing apparatus 1 is configured to execute wireless communication according to some wireless communication standards, for instance, WiFi®, third-generation mobile communication (3G), Bluetooth®, etc. Using the wireless communication function, the information processing apparatus 1 can communicate with an external communication device 3. The external communication device 3 is, for example, a wireless access point or various servers on the Internet.

The information processing apparatus 1 includes an install restriction function for restricting install of an application program in the information processing apparatus 1. In order to realize the install restriction function, the information processing apparatus 1 includes three different modules, namely an access detection/control module 10, a management application module 21 and a determination application module 22.

The access detection/control module 10 can be realized by a software module in an operating system (OS) layer. This software module may be, for example, middleware in the OS layer, or a kernel in the OS layer such as a Linux® kernel. Each of the management application module 21 and determination application module 22 can be realized by an application program which is executed on an application execution module 20. This application program may be, for example, an Android® application program.

The application execution module 20 is a platform for executing various application programs, and can be realized by, for example, a virtual machine such as a Java® virtual machine.

The information processing apparatus 1 can download various application programs (various application package files) from an application delivery server 4 via the Internet. Each application program, which is downloaded, is stored in a storage device 30 in the information processing apparatus 1. The determination application module 22 is also downloaded from the application delivery server 4 and stored in the storage device 30. Each of the management application module 21 and an installer module 23 can also be downloaded from the application delivery server 4. Incidentally, the management application module 21 and the installer module 23 may be pre-installed in the information processing apparatus 1. In this case, it is not always necessary to download the management application module 21. Similarly, it is not always necessary to download the installer module 23.

The installer module 23 executes a process of expanding the application package file of each application program (management application module 21, determination application module 22 and other various applications) which has been downloaded from the application delivery server 4, and installing each application program in the storage device 30.

The application execution module 20 loads each application program (management application module 21, determination application module 22, installer module 23 and other various applications) from the storage device 30 and executes each application program.

The access detection/control module 10 detects an event of requesting install or uninstall of an application program, notifies, prior to the execution of the event, that is, prior to execution of install or uninstall, the management application module 21 of the name of the application that is the target of install or uninstall, and controls the execution of install or uninstall, based on an instruction from the management application module 21.

For example, if the access detection/control module 10 detects an event of requesting install of a certain application program, the access detection/control module 10 suspends a process of installing the application program, and transmits install event information including the application name of the application program to the management application module 21. Then, based on a determination result indicative of permission or prohibition of install, which is returned from the management application module 21, the access detection/control module 10 executes the install process or cancels (prohibits) the execution of the install process.

Similarly, if the access detection/control module 10 detects an event of requesting uninstall of a certain application program, the access detection/control module 10 suspends a process of uninstalling the application program, and transmits uninstall event information including the application name of the application program to the management application module 21. Then, based on a determination result indicative of permission or prohibition of uninstall, which is returned from the management application module 21, the access detection/control module 10 executes the uninstall process or cancels (prohibits) the execution of the uninstall process.

Besides, the access detection/control module 10 can detect other various events, as well as the event of requesting install or uninstall of the application program. For example, the access detection/control module 10 detects connection requests for connection to various communication devices (e.g. a request for connection to a WiFi® access point, a request for connection to a VPN, and a request for connection to a Bluetooth® device), an SD card connection request, a USB memory connection request, and a request for starting an application program. Also when an event other than the install/uninstall event has been detected, the access detection/control module 10 can transmit, prior to the execution of this event, event information indicative of the detected event to the management application module 21, and can control permission/prohibition of the execution of the event, based on an instruction from the management application module 21.

The management application module 21 functions as a manager configured to provide an environment for install restriction of each of application programs. When the management application module 21 is started, the management application module 21 can request the access detection/control module 10 to notify the management application module 21 of various events such as an install event. Further, if the management application module 21 receives event information from the access detection/control module 10, the management application module 21 notifies the determination application module 22 of the content of the received event information, and transmits a determination result (e.g. a determination result indicative of permission or prohibition of an install event), which is received from the determination application module 22, to the access detection/control module 10.

The determination application module 22 has a predetermined policy (determination rule). Based on the policy, the determination application module 22 determines permission or prohibition of install of an application program corresponding to the application name included in the event information of the install event which is received from the management application module 21, and notifies the management application module 21 of the determination result. Incidentally, the determination application module 22 can download, where necessary, a policy (determination rule) from a policy delivery server 5. By downloading the policy (determination rule) from the policy delivery server 5, the determination application module 22 can easily update the policy, for example, at regular intervals. In addition, a policy may be embedded in advance in the determination application module 22. In this case, the policy can be updated by upgrading the version of the determination application module 22 itself which is to be executed by the application execution module 20. Furthermore, the determination application module 22 can inquire of an event permission/prohibition determination server 6 about permission/prohibition of execution of an event.

When the determination result notified by the management application module 21 is indicative of prohibition of install, the access detection/control module 10 prohibits install (e.g. creation of a directory (folder) or a file). Thereby, install of an application program, the use of which is not permitted, can be prevented. On the other hand, when the determination result notified by the management application module 21 is indicative of permission of install, the access detection/control module 10 executes the install process for installing the application program.

The installer module 23 instructs the access detection/control module 10 to start install or uninstall of an application program, in accordance with a user operation. In accordance with an instruction from the installer module 23, the access detection/control module 10 can detect an install event or an uninstall event.

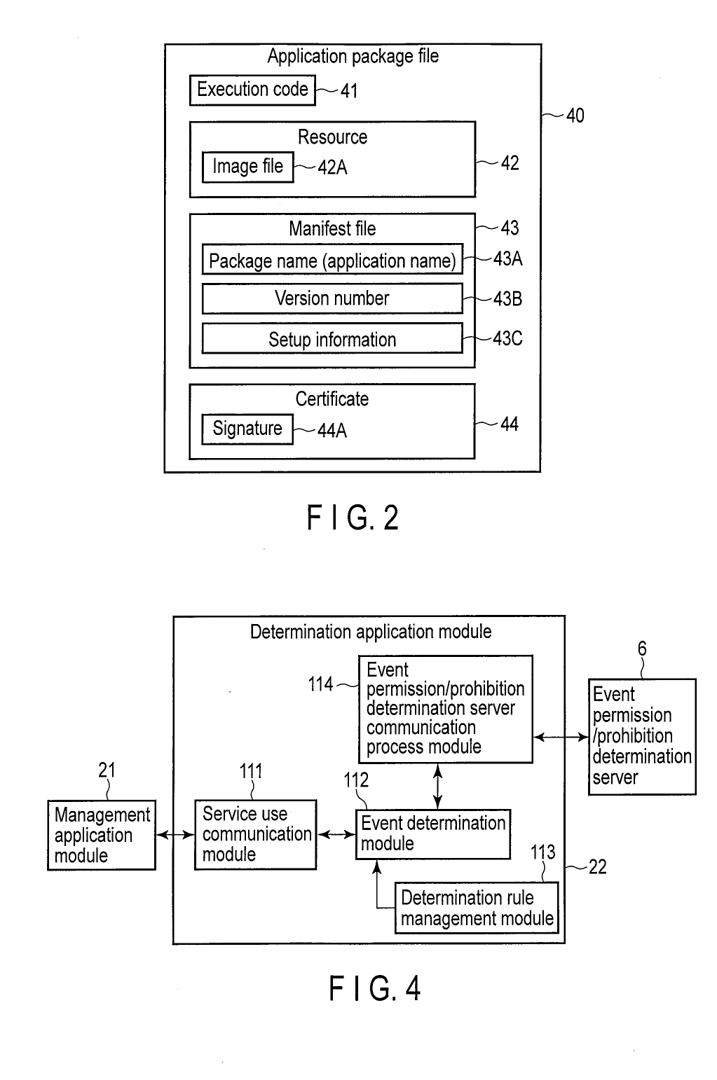

FIG. 2 shows a structure of an application package file 40 which is used in the information processing apparatus 1. As shown in FIG. 2, an application name (package name) and a certificate including a signature are given to each application package file 40.

To be more specific, each application package file 40 includes an execution code 41, a resource 42, a manifest file 43 and a certificate 44. The resource 42 includes an image file 42A such as a thumbnail image file which is used as an icon. The manifest file 43 includes a package name (application name) 43A, a version number 43B and setup information 43C.

The certificate 44 is information for confirming the developer of the application package file 40 and for certifying that the application package file 40 is not illegitimately modified, and the certificate 44 includes an electronic signature (signature 44A). The signature 44A is calculated by, for example, a public key encryption using a secret key possessed by the developer of the application program, and a message. This message may be a digest value of each file (execution code 41, resource 42, manifest file 43) included in the application package file 40. As a public key encryption algorithm that is used for signature calculation, use may be made of a well-known public key algorithm such as RSA or EC-DSA.

The secret key that is used for the signature varies from application developer to application developer. In the present embodiment, it is assumed that the secret key that is used for the signature of the management application module 21 is different from the secret key that is used for the signature of the determination application module 22. Specifically, it is assumed that the management application module 21 and determination application module 22 have been developed by different application developers.

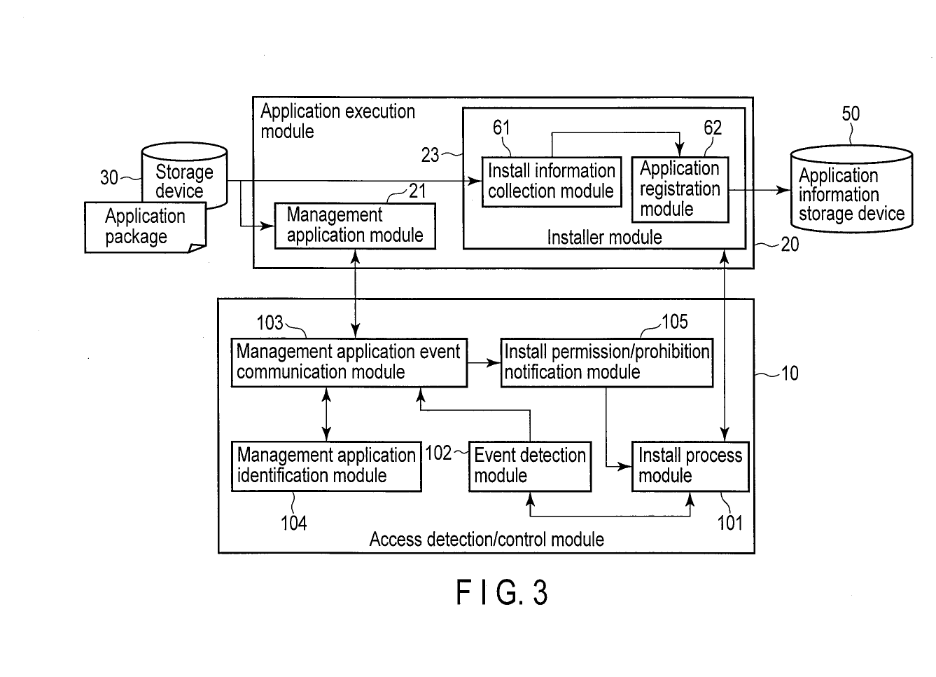

FIG. 3 shows configurations of the above-described access detection/control module 10 and application execution module 20. The case is assumed that only install restriction is executed.

As shown in FIG. 3, the installer module 23 (install application) starts an instruction for install or uninstall. At a time of install, an install information collection module 61 of the installer module 23 acquires, from the storage device 30, an application package file corresponding to an application that is an install target. Then, an application registration module 62 of the installer module 23 registers the install-target application in an application information storage device 50 that is a database which stores a thumbnail image file, etc. An actual install process, such as file creation, is executed by the access detection/control module 10.

The access detection/control module 10 includes an install process module 101, an event detection module 102, a management application event communication module 103, a management application identification module 104 and an install permission/prohibition notification module 105.

Upon receiving an instruction for starting install (an install request) from the installer module 23, the install process module 101 causes the installer module 23 to wait for the execution of the process of install. The occurrence of the install request is detected as an install event by the event detection module 102. The management application event communication module 103 notifies the management application module 21 of the install event and the event information (install event information) including the application name of the install target.

The management application identification module 104 identifies which of applications on the application execution module 20 is the management application module 21. After detected by the event detection module 102, the event information (install event information) is transmitted, via the management application event communication module 103, to the application which has been identified as the management application module 21 by the management application identification module 104. Specifically, the management application identification module 104 prestores the application name of the management application module 21. Then, upon receiving a registration request from the application, the management application identification module 104 determines, based on the prestored application name, whether this application is the management application module 21 (the application program having the prestored application name), that is, whether this application is a communication counterpart to which the install event information is to be transmitted. If it has been determined that the application is the communication counterpart to which the install event information is to be transmitted, this application is identified as the management application module 21. Except for update of the application, the installation in the system of two applications having the same application name is restricted by the installer module 23. Therefore, by prestoring the application name of the management application module 21 in the management application identification module 104, the management application module 21 can uniquely be identified.

The management application event communication module 103 executes communication with the application program which has been identified by the management application identification module 104. Thereby, the event information can be prevented from being intercepted by a malicious application program.

Upon receiving a determination result from the management application module 21, the management application event communication module 103 outputs the received determination result to the install permission/prohibition notification module 105. The install permission/prohibition notification module 105 controls the operation of the install process module 101, based on the content of the determination result. If the determination result is indicative of permission of install, the install process module 101, in cooperation with the installer module 23, executes the install process. On the other hand, if the determination result is indicative of prohibition of install, the install process module 101 cancels the install process.

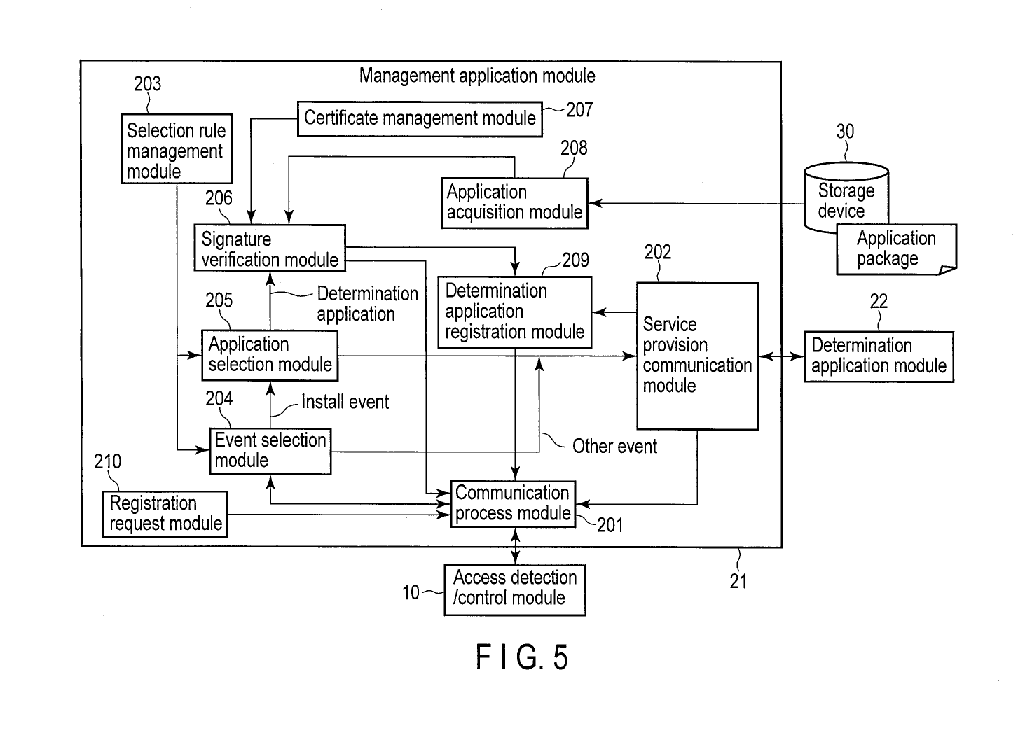

FIG. 4 shows a configuration of the determination application module 22. As shown in FIG. 4, the determination application module 22 includes a service use communication module 111, an event determination module 112, a determination rule management module 113 and an event permission/prohibition determination server communication process module 114.

The service use communication module 111 communicates with the management application module 21. Based on a rule set (determination rule) which is present in the determination rule management module 113, the event determination module 112 determines permission or prohibition of install of an application program corresponding to the application name included in the install event information. The rule set (determination rule) may be, for example, a list (white list) of application names, the install of which is to be permitted, a list (black list) of application names, the install of which is to be prohibited, or a list of application names, the uninstall of which is to be permitted (or a list of application names, the uninstall of which is to be prohibited).

The event permission/prohibition determination server communication process module 114 inquires of the event permission/prohibition determination server 6 about permission/prohibition of install of an application program corresponding to the application name included in the install event information, and receives permission/prohibition of install from the event permission/prohibition determination server 6. The event determination module 112 can determine, where necessary, permission/prohibition of install by using the event permission/prohibition determination server communication process module 114.

In the meantime, it is not always necessary that both the determination rule management module 113 and the event permission/prohibition determination server communication process module 114 be provided in the determination application module 22. Such a configuration may be adopted that only either the determination rule management module 113 or the event permission/prohibition determination server communication process module 114 is provided in the determination application module 22.

The event determination module 112 may execute not only determination of permission or prohibition of an install event, but also determination of permission or prohibition of various events, such as connection requests for connection to various communication devices (e.g. a request for connection to a WiFi® access point, a request for connection to a VPN, and a request for connection to a Bluetooth® device), an SD card connection request, a USB memory connection request, and a request for starting an application program, based on the rule set that is present in the determination rule management module 113, or by using the event permission/prohibition determination server 6.

FIG. 5 shows a configuration of the management application module 21. When the determination application module 22 (determination program) is to be installed, the management application module 21 confirms the integrity of the determination application module 22, based on a certificate or the like which is given to the determination application module 22. When the integrity of the determination application module 22 has been confirmed, the management application module 21 identifies the determination application module 22 as the communication counterpart to which event information, such as install event information, is to be notified.

The management application module 21 includes a communication process module 201, a service provision communication module 202, a selection rule management module 203, an event selection module 204, an application selection module 205, a signature verification module 206, a certificate management module 207, an application acquisition module 208, a determination application registration module 209, and a registration request module 210.

The communication process module 201 communicates with the access detection/control module 10. The communication process module 201 receives, from the access detection/control module 10, various events which are notified from the access detection/control module 10 (an install event, connection request events for connection to various communication devices, an SD card connection request event, a USB memory connection request event, an uninstall event, etc.). In the meantime, a method, such as a signal system call, may be used for the communication between the management application module 21 and the access detection/control module 10.

The service provision communication module 202 notifies the content of an event to the determination application module 22 which is registered in the determination application registration module 209, that is, the determination application module 22 which has been confirmed to be the authenticated determination application, and receives from the determination application module 22 a determination result indicative of permission or prohibition of execution of the event. Incidentally, a method, such as inter-process communication, may be used for the communication between the management application module 21 and the determination application module 22.

The selection rule management module 203 stores a selection rule for classifying various events, which are notified from the access detection/control module 10, into an install event and other events. In the selection rule, for example, the event name for identifying the install event (application install event) and at least one application name (determination application name), which is usable as the determination application, are stored.

The event selection module 204 determines whether the event, which has been received from the access detection/control module 10, is an install event. If the received event is an install event, the event selection module 204 transmits to the application selection module 205 the content of the received event, that is, the install event and the application name associated with this install event. If the received event is an event other than an install event, the event selection module 204 transmits the content of the received event to the service provision communication module 202.

The application selection module 205 determines whether the application name, which has been received from the event selection module 204, is the determination application name which is stored in the selection rule management module 203, thereby determining whether the install-target application is the determination application. If the install-target application is the determination application, the application selection module 205 transmits the application name of this determination application to the signature verification module 206, and notifies the signature verification module 206 that the install-target application is the determination application. On the other hand, if the install-target application is an application other than the determination application, the application selection module 205 transmits to the service provision communication module 202 the install event information including the application name of the install-target application.

If the install-target application is the determination application module 22, the signature verification module 206 executes signature verification for the determination application module 22, and determines whether the install-target determination application module 22 is an authenticated determination application. In the signature verification, the signature verification module 206 instructs the application acquisition module 208 to acquire the application package file of the determination application which is stored in the storage device 30, and determines whether the determination application module 22 is an authenticated determination application, based on the certificate 40, etc. included in this application package file.

The certificate management module 207 functions as a public key storage module including a public key for verifying the certificate which is given to the determination application. This certificate management module 207 stores, for example, public keys corresponding to respective creators. The above-described signature verification may be executed based on this public key, the signature 44A included in the certificate 40, and the files (execution code 41, resource 42, manifest file 43) included in the application package file 40. By this signature verification, it is verified whether the developer of the application package file of the determination application is correct or not, and whether the application package file is not illegitimately modified and is authenticated.

Only when the signature verification has successfully been executed, does the signature verification module 206 register the application name of the install-target determination application module 22 in the determination application registration module 209. The determination application registration module 209 transmits the determination result, which is indicative of permission of install of the determination application module 22 that is the install target, to the access detection/execution module 10 via the communication process module 201. Thereby, the install of the determination application module 22 is executed by the access detection/execution module 10. The service provision communication module 202 communicates with only the application which is registered in the determination application registration module 209. Specifically, only when the signature verification of the determination application module 22 has successfully been executed, will the management application module 21 transmit subsequent events to the determination application module 22.

When the signature verification has failed, the signature verification module 206 notifies the access detection/control module 10 via the communication process module 201 that the install is prohibited. Based on this instruction, the access detection/control module 10 prohibits the install of the determination application that is the install target. As a result, this application is not installed. Alternatively, the signature verification module 206 may notify the determination application registration module 209 that the signature verification has failed, and the determination application registration module 209, which has received this notification, may not register the application name and may transmit the determination result, which is indicative of permission of install of the determination application module 22 that is the install target, to the access detection/execution module 10 via the communication process module 201. In this case, the install of the application itself, which is the install target, is executed, but the management application module 21 does not register this application as the determination application module 22, and thus subsequent events will not be transmitted to this application.

The registration request module 210 is a process module which transmits, when the management application module 21 is activated, a request to the access detection/control module 10 via the communication process module 201, the request asking the access detection/control module 10 to transmit events, which will subsequently be detected by the access detection/control module 10, to the management application module 21.

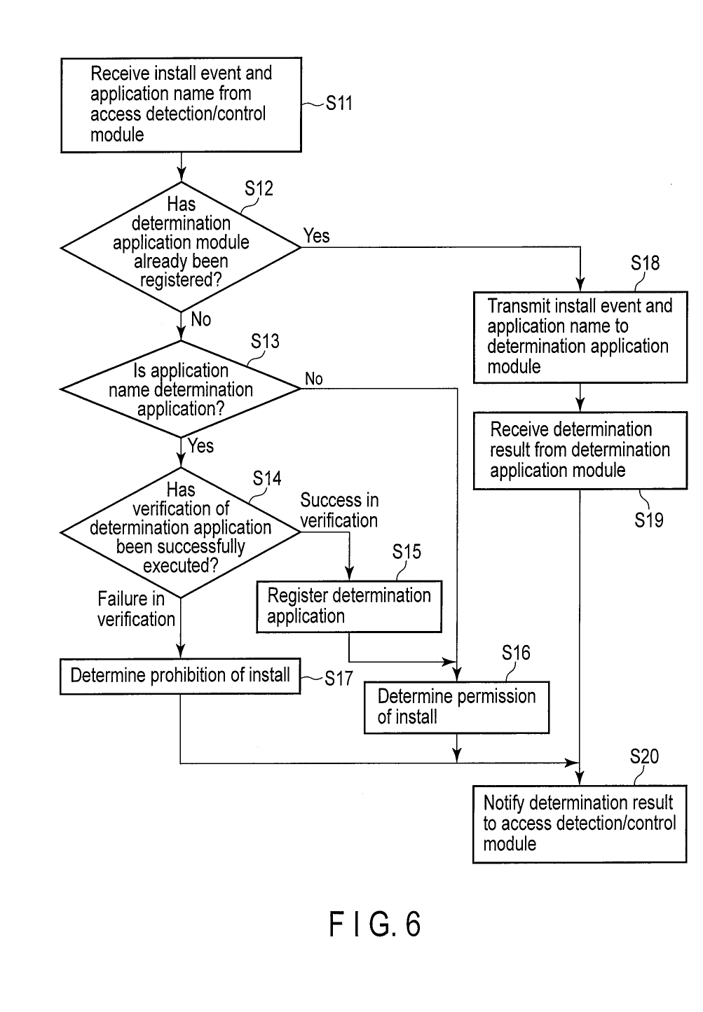

FIG. 6 illustrates the procedure of an install event process which is executed by the management application module 21.

The management application module 21 receives from the access detection/control module 10 install event information, i.e. an install event and an application name (step S11). The management application module 21 determines whether the determination application module 22 has already been registered or not (step S12).

If the determination application module 22 has not been registered (No in step S12), the management application module 21 determines whether the application name that is the install target is the application name of the determination application (step S13).

If the install-target application name has the application name of the determination application, that is, if the application name of the install target is the determination application (Yes in step S13), the management application module 21 executes signature verification, based on the signature that is given to the determination application, and confirms integrity of the determination application (step S14).

If the integrity of the determination application has been confirmed (success in verification), the management application module 21 registers the application name of the determination application, and identifies this determination application as the communication counterpart to which install event information is to be notified (step S15). Then, the management application module 21 determines permission of install (step S16), and notifies the access detection/control module 10 of the determination result indicative of the permission of install (step S20).

If the integrity of the determination application has not been confirmed (failure in verification), the management application module 21 determines prohibition of install (step S17), and notifies the access detection/control module 10 of the determination result indicative of the prohibition of install (step S20). In the meantime, the determination application, the integrity of which has not been confirmed as described above, may not be registered in the determination application registration module 209, and instead, the install itself of the determination application, the integrity of which has not been confirmed, may be permitted.

If the determination application module 22 has already been registered (Yes in step S12), the management application module 21 transmits the install event and the application name, which have been received from the access detection/control module 10, to the determination application module 22 (step S18). Then, the management application module 21 receives the determination result, which is indicative of permission or prohibition of install, from the determination application 22 (step S19), and notifies the received determination result to the access detection/control module 10.

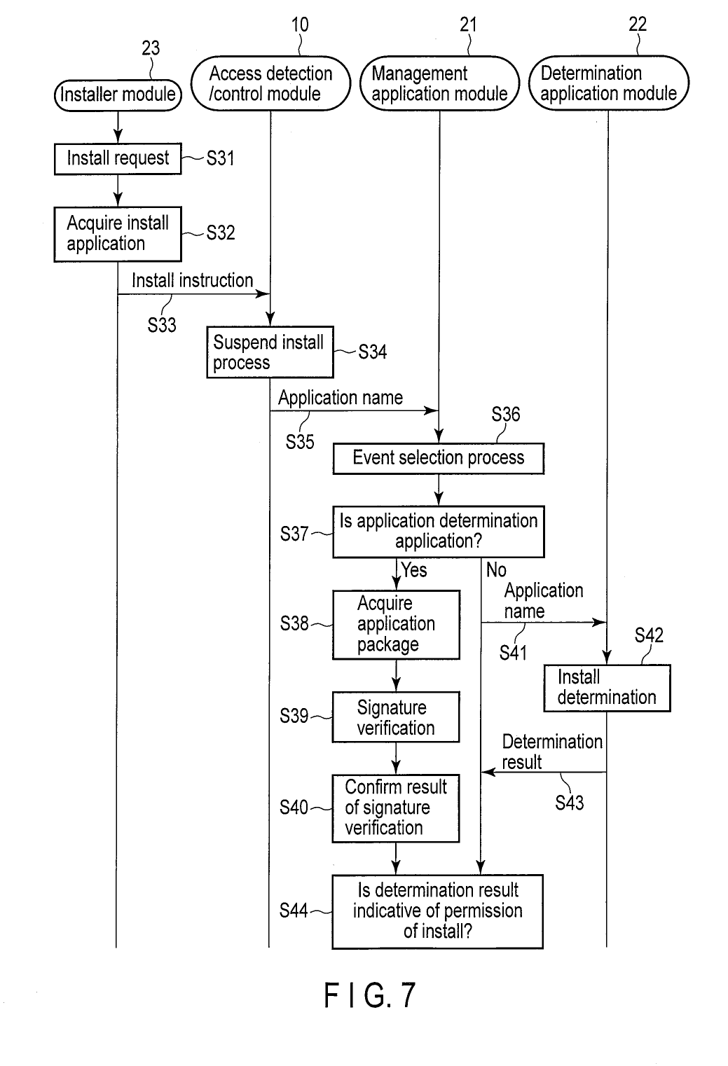

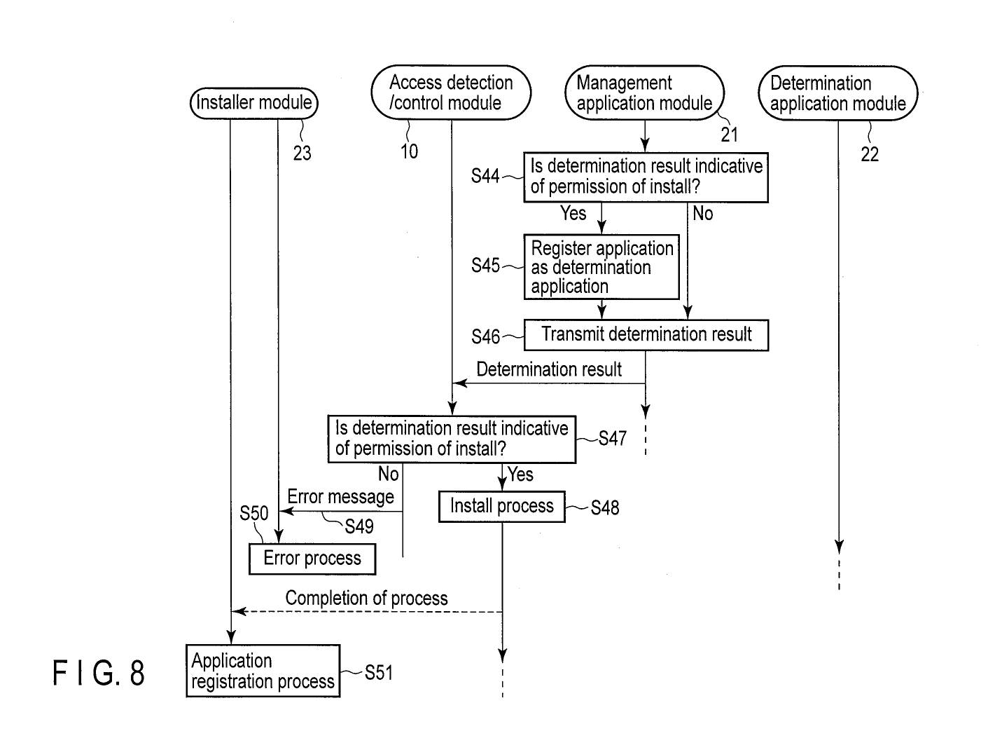

Next, referring to flowcharts of FIG. 7 and FIG. 8, a description is given of the procedure of a process which is executed by the installer module 23, access detection/control module 10, management application module 21 and determination application module 22.

If an install request occurs in accordance with an application install operation by the user (step S31), the installer module 23 acquires an application package file corresponding to an application that is an install target (step S32). Then, the installer module 23 transmits an install instruction for install of the install-target application to the access detection/control module 10 (step S33).

Upon receiving the install instruction, the access detection/control module 10 detects the occurrence of an event of requesting install of the application. The access detection/control module 10 suspends the execution of the install process (step S34). Prior to the execution of the install process, the access detection/control module 10 notifies the management application module 21 of the install event and the application name of the install target (step S35).

The management application module 21 executes an event selection process of determining whether the event, which has been notified from the access detection/control module 10, is an install event or not (step S36). In this case, since the notified event is an install event, the process advances to step S37.

In step S37, the management application module 21 determines whether the application name notified from the access detection/control module 10 is the application name of the determination application (step S37). If the notified application name is the application name of the determination application (Yes in step S37), the management application module 21 acquires an application package file corresponding to the application that is to be installed by the installer module 23 (step S38), and executes signature verification for confirming the authenticity of the determination application, by using the certificate (signature) given to the application package file and the public key corresponding to the certificate (signature) (step S39). Then, the management application module 21 confirms the result of the signature verification (step S40), and determines whether or not to permit install, in accordance with the result of the signature verification (step S44).

On the other hand, if the application name notified from the access detection/control module 10 is not the application name of the determination application (No in step S37), the management application module 21 notifies the determination application module 22 of the install event and the notified application name (step S41). Based on the notified application name, the determination application module 22 determines whether or not to permit install of the application (step S42), and sends the determination result to the management application module 21 (step S43).

As illustrated in FIG. 8, if the signature verification has been successfully executed and the permission of install of the determination application has been determined (Yes in step S44), the management application module 21 registers this determination application as the communication counterpart to which event information is to be transmitted (step S45), and transmits the determination result indicative of the permission of install to the access detection/control module 10 (step S46). On the other hand, if the signature verification has failed and the prohibition of install of the determination application has been determined (No in step S44), the management application module 21 transmits the determination result indicative of the prohibition of install to the access detection/control module 10 (step S46).

If the install-target application is an application other than the determination application, the management application module 21 transmits the determination result, which has been received from the determination application module 22, as such to the access detection/control module 10 (step S46).

The access detection/control module 10 determines whether the determination result received from the management application module 21 is indicative of permission of install or not (step S47). If the determination result is indicative of prohibition of install (No in step S47), the access detection/control module 10 returns an error message to the installer module 23, without executing the install process of the install-target application (step S49). The installer module 23 executes an error process, such as notifying the user of the error of install (step S50).

On the other hand, if the determination result is indicative of permission of install (Yes in step S47), the access detection/control module 10 executes the install process for installing the install-target application (step S48). In the install process, for example, a file corresponding to the application package file is created at a predetermined directory. Then, if the install process is completed, the installer module 23 registers, for instance, a thumbnail image file in the application package file in the application information storage device 50 (step S51).

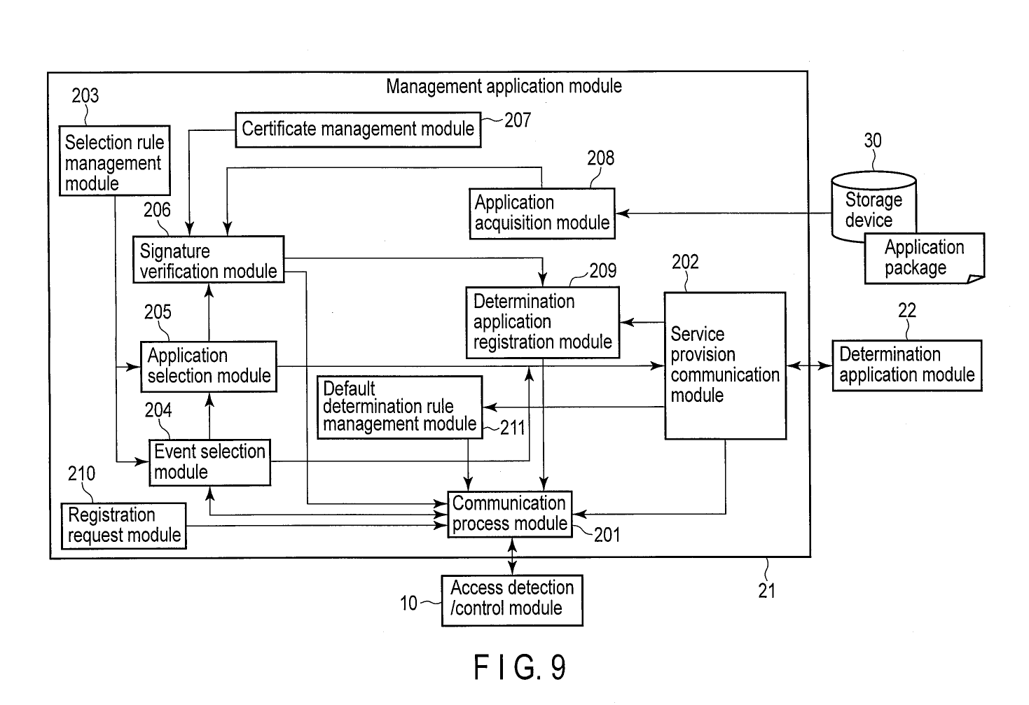

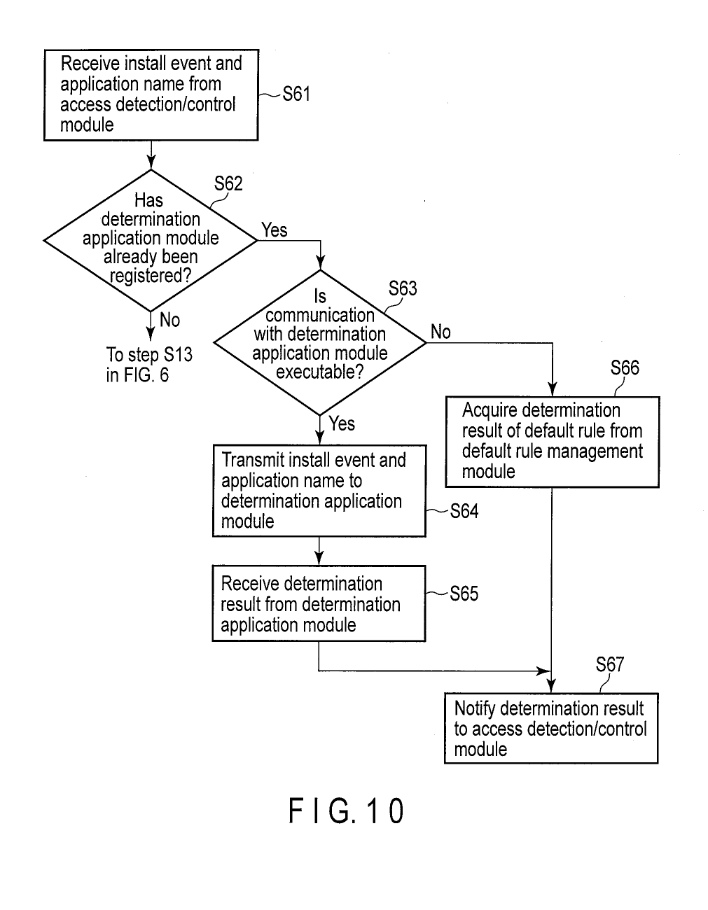

FIG. 9 illustrates a configuration of the management application module 21 in which a default determination rule management module 211 is added.

The management application module 21 includes a default policy (default determination rule) for determining permission or prohibition of install of individual applications. In the case where communication with the determination application module 22, which is identified by the application name registered in the determination application registration module 209, is not executable due to some cause, the management application module 21 determines permission or prohibition of install of the application corresponding to the application name designated by the install event, according to a default determination rule which is stored in the default determination rule management module 211.

A flowchart of FIG. 10 illustrates a process procedure of the management application module 21 of FIG. 9.

The management application module 21 receives from the access detection/control module 10 install event information, i.e. an install event and an application name (step S61). The management application module 21 determines whether the determination application module 22 has already been registered or not (step S62).

If the determination application module 22 has not been registered (No in step S62), the management application module 21 advances to step S13 in FIG. 6.

On the other hand, if the determination application module 22 has already been registered (Yes in step S62), the management application module 21 determines whether communication with the determination application module 22 is executable or not (step S63). If the communication with the determination application module 22 is normally executable (Yes in step S63), the management application module 21 transmits the install event and the application name to the determination application module 22 (step S64). Then, the management application module 21 receives the determination result, which is indicative of permission or prohibition of install, from the determination application 22 (step S65), and notifies the received determination result to the access detection/control module 10 (step S67).

If the communication with the determination application module 22 is not executable (No in step S63), the management application module 21 acquires a determination result according to the default rule from the default determination rule management module 211 (step S66), and notifies the acquired determination result to the access detection/control module 10 (step S67).

The above description has been given of the case of using the default rule of the default determination rule management module 211 when the communication with the registered determination application module 22 is not executable. Alternatively, the service provision communication module 202 may determine whether the determination application is registered in the determination application registration module 209, and the service provision communication module 202 may notify the determination application module 22 of the event information (install event and application name) if the determination application is registered, and may notify the default determination rule management module 211 of the event information if the determination application is not registered. When the default determination rule management module 211 has received the event information, the default determination rule management module 211 transmits the determination result indicative of permission or prohibition of install to the access detection/control module 10 via the communication process module 201.

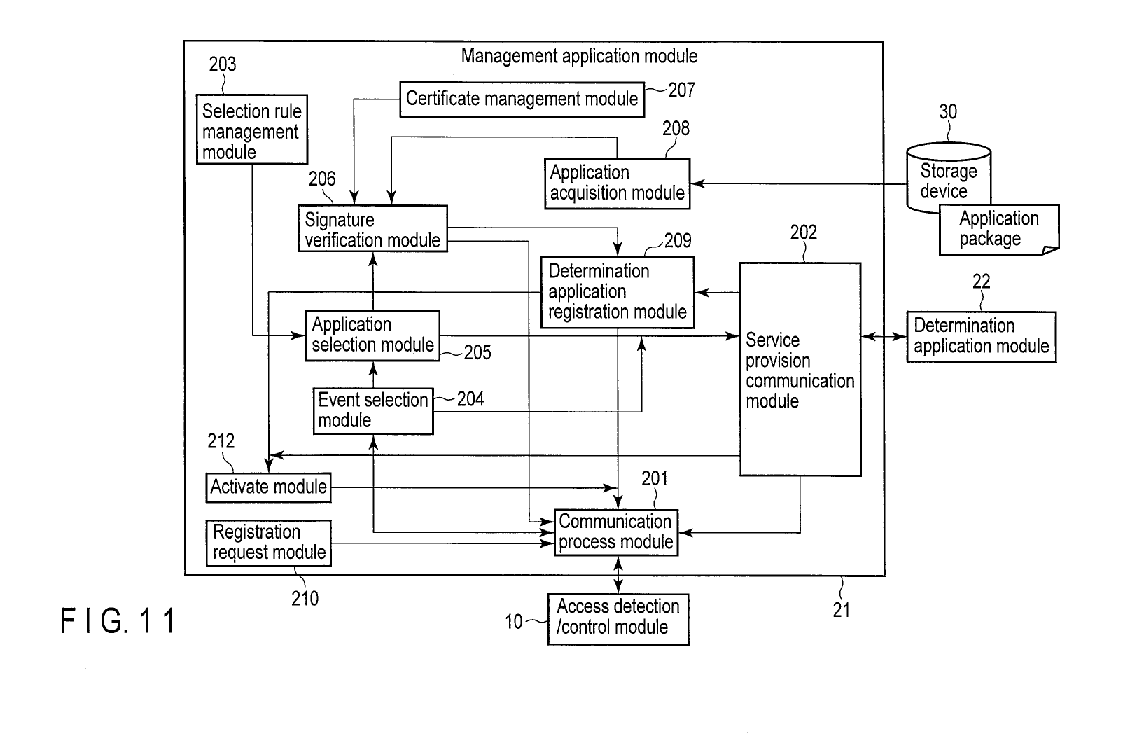

FIG. 11 illustrates a configuration of the management application module 21 in which an activate module 212 is added.

In the configuration of the management application module 21 which has been described with reference to FIG. 5 and FIG. 9, it is assumed that all events, including an install event and events other than the install event, are always notified to the management application module 21. In the configuration of the management application module 21 of FIG. 11, it is assumed that in the initial state (the state in which the determination application is not installed), events other than the install event are not notified to the management application module 21. When the determination application module 22 has been installed (i.e. when a connection request has first come to the service provision communication module 202 from the determination application module 22), the activate module 212 instructs the access detection/control module 10 to notify not only the install event but also the events other than the install event. Thereby, hereafter, the access detection/control module 10 notifies all events to the management application module 21.

In addition, when a connection request has first come to the service provision communication module 202 from the determination application module 22, the management application module 21 may execute the above-described signature verification and may confirm the integrity of the determination application module 22. Then, on condition that the integrity of the determination application module 22 has been confirmed, that is, on condition that the determination application module 22 has been registered, the activate module 212 may instruct the access detection/control module 10 to notify not only the install event but also the events other than the install event.

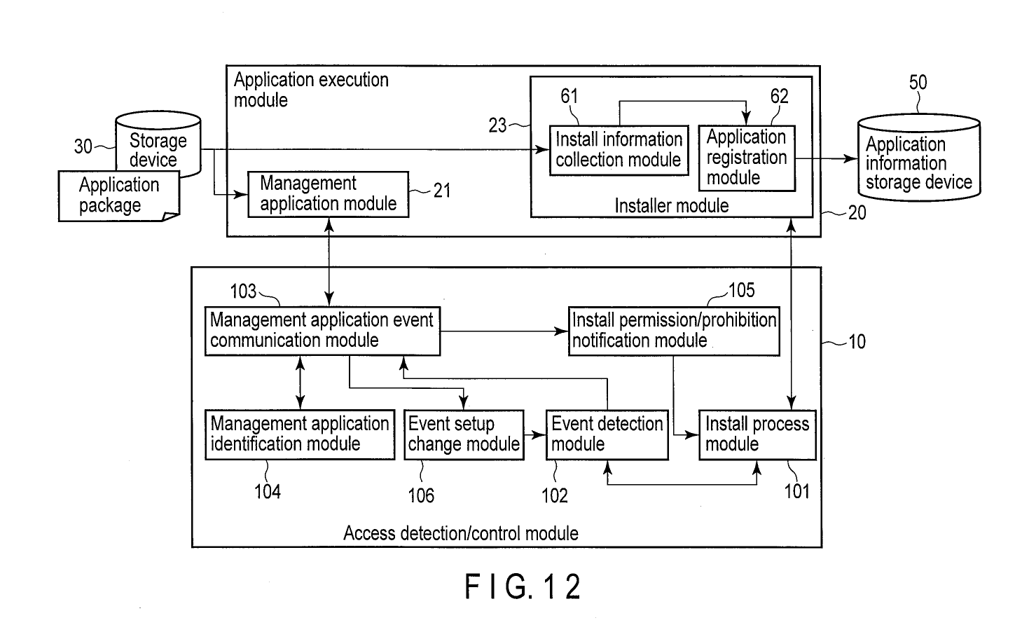

FIG. 12 illustrates a configuration of the access detection/control module 10, which corresponds to the configuration of the management application module 21 of FIG. 11.

As shown in FIG. 12, an event setup change module 106 is added to the access detection/control module 10. The access detection/control module 10 transmits all install events to the management application module 21, in order to determine permission/prohibition of update of the management application module 21 and to determine permission/prohibition of install of the determination application module. However, the access detection/control module 10 does not transmit events other than the install event, until receiving an activation instruction from the management application module 21. After receiving the activation instruction, the access detection/control module 10 transmits events other than the install event to the management application module 21.

The event setup change module 106 sends to the event detection module 102 an instruction as to which event is to be transmitted to the management application module 21. Upon receiving the activation instruction from the management application module 21, the event setup change module 106 instructs the event detection module 102 via the event setup change module 106 to transmit all events to the management application module 21.

Specifically, the access detection/control module 10 includes a determination rule for determining permission/prohibition of execution of an event other than the install event, and determines, according to this determination rule, permission/prohibition of execution of an event other than the install event, until receiving a predetermined instruction (activation instruction) from the management application module 21. Then, if the access detection/control module 10 receives the activation instruction, the event setup change module 106 updates the determination rule, based on the activation instruction, so that all events are transmitted to the management application module 21. Thereby, the access detection/control module 10 inquires of the management application module 21 also about permission/prohibition of execution of each event other than the install event.

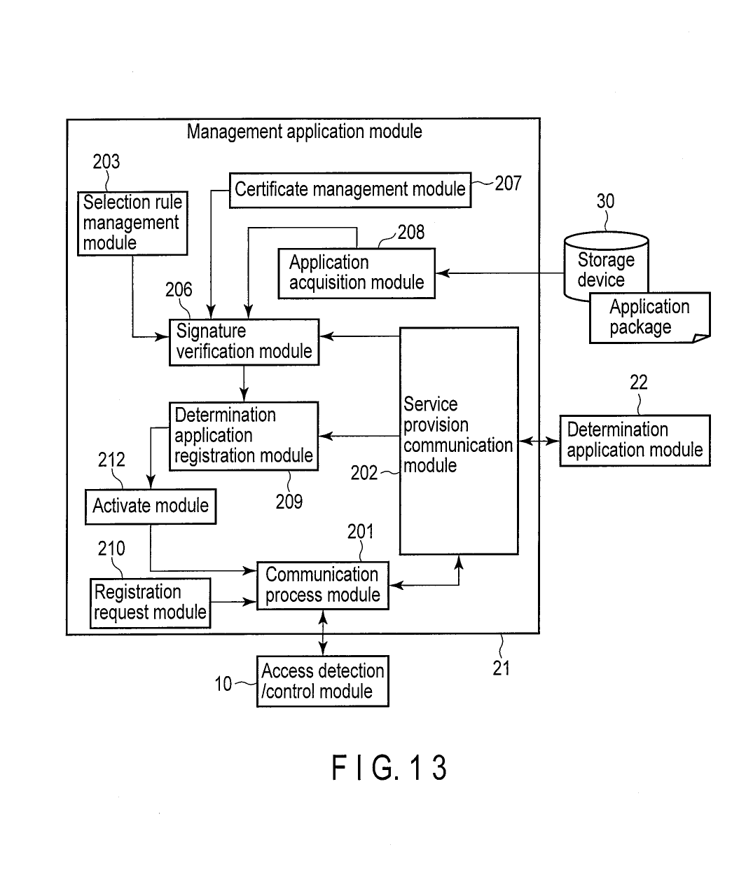

FIG. 13 illustrates another configuration of the management application module 21.

The above-description has been given of the process procedure in which signature verification is executed in response to reception of an install event of a determination application, thereby confirming the integrity of the determination application. In the configuration of the management application module 21 of FIG. 13, the case is assumed that the process of confirming the integrity of the determination is executed in response to reception of a registration request from the installed determination application. In other words, the management application module 21 confirms the integrity of the determination program, based on the request of the determination program, after the determination application is installed in the information processing apparatus 1. If the integrity of the determination program has been confirmed, the management application module 21 instructs the access detection/control module 10 to transmit event information, such as install event information, in response to detection of each event such as an install event.

Specifically, in the management application module 21 of FIG. 13, in the initial state (the state in which the determination application is not installed), none of events including an install event is notified from the access detection/control module 10. Specifically, in FIG. 12, the case is assumed that the access detection/control module 10 is configured to notify, in the initial state, only the install event to the management application module 21. However, in this example, the case is assumed that the access detection/control module 10 is configured to notify, in the initial state, none of events to the management application module 21.

The management application module 21 does not detect the install event itself of the determination application module 22. When a registration request has been transmitted from the determination application module 22 to the service provision communication module 202, the management application module 21 identifies the application name of the determination application module 22, and checks whether this application name agrees with the determination application name which is stored in the selection rule management module 203. If the application names agree, the management application module 21 executes the above-described signature verification by the signature verification module 206, thereby to confirm that the determination application module 22 is not a false determination application. If it is confirmed that the determination application module 22 is the authenticated determination application, the management application module 21 instructs the event detection module 102 by the activate module 212 to transmit all events to the management application module 21.

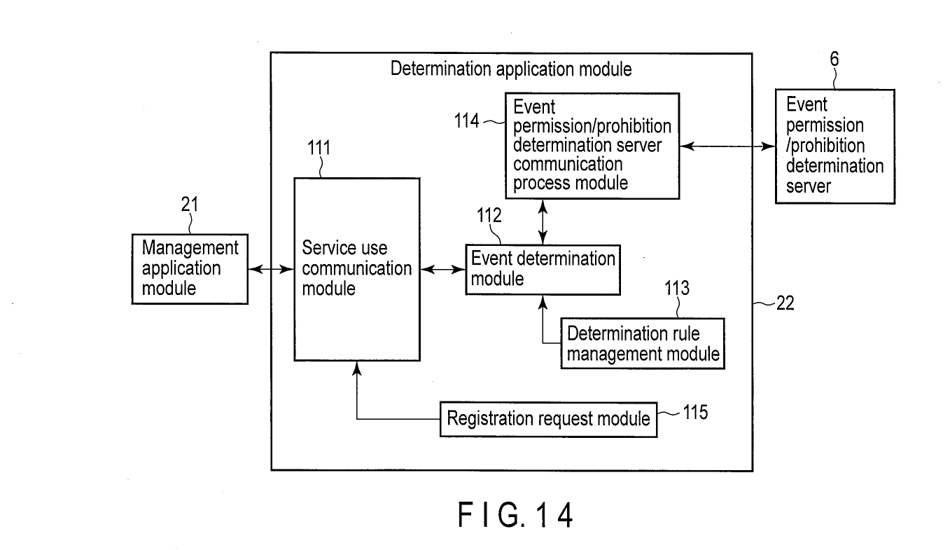

FIG. 14 illustrates a configuration of the determination application module 22, which corresponds to the management application module 21 of FIG. 13. The difference from FIG. 4 is the provision of a registration request module 115.

The registration request module 115 is a process module which transmits, when the determination application module 22 has been started, an instruction to the management application module 21 via the service use communication module 111, thereby requesting the management application module 21 to execute a registration process for registering the determination application module 22. If the determination application module 22 is registered in the management application module 21, the management application module 21 transmits subsequent events to the determination application module 22.

In this configuration, no communication occurs between the management application module 21 and the determination application module 22, until the determination application module 22 is registered in the management application module 21. Thus, the amount of communication can be reduced. Install of the determination application module 22 is executed when the information processing apparatus 1 is used in business work in a company. If it is confirmed that the installed determination application module 22 is the authenticated determination application module, all events are hereafter notified to the management application module 21 from the access detection/control module 10.

The communication process module 201 of the management application module 21 transmits to the service provision communication module 202 all events that have been received from the access detection/control module 10. The service provision communication module 202 transmits each event, which has been received from the communication process module 201, to the determination application module 22, and transmits a determination result indicative of permission/prohibition of execution of each event, which is received from the determination application module 22, to the communication process module 201.

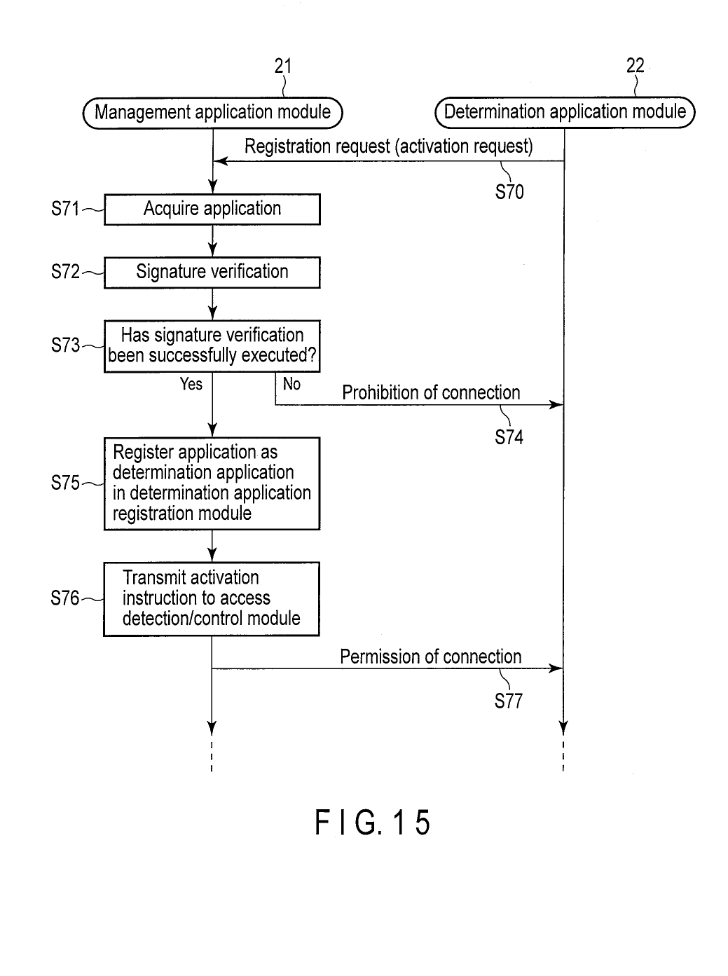

FIG. 15 illustrates the procedure of a determination application registration process which is executed by the management application module 21 of FIG. 13.

If the determination application module 22 is installed, the determination application module 22 transmits a registration request (activate request) to the management application module 21 (step S70). The management application module 21 acquires an application package file corresponding to the application name of the determination application module 22 (step S71). Then, the management application module 21 executes the above-described signature verification by using the certificate (signature) given to the application package file, and determines whether the determination application module 22 is an authenticated determination application which is not illegitimately modified (step S72).

If the signature verification has failed (No in step S74), the management application module 21 prohibits a connection to the determination application module 22 (step S74).

On the other hand, if the signature verification has successfully been executed (Yes in step S73), the management application module 21 identifies the application name of the determination application module 22 as the application name of the communication counterpart to which event information is to be notified, and registers the identified application name (step S75). The management application module 21 transmits the activation instruction to the access detection/control module 10, thereby instructing the access detection/control module 10 to notify all events, which will be detected hereafter, to the management application module 21 (step S76). Then, the management application module 21 permits a connection to the determination application module 22, and returns, where necessary, a response indicative of permission of connection to the determination application module 22 (step S77).

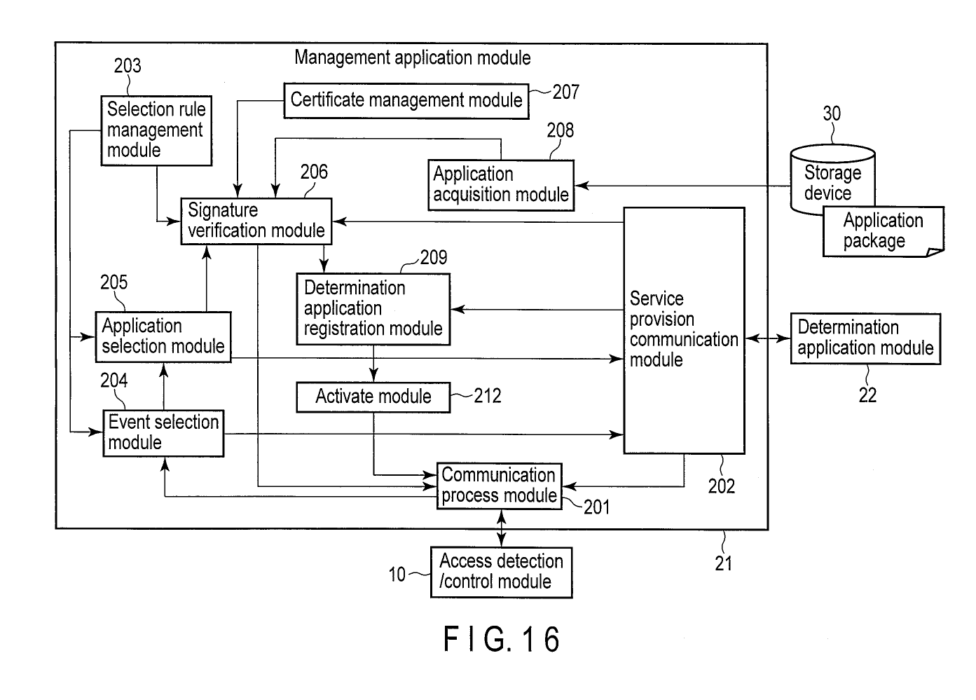

FIG. 16 illustrates another configuration of the management application module 21.

In FIG. 13, the description has been given of the configuration in which the process of confirming the integrity of the determination application is executed in response to the reception of the registration request from the installed determination application. In the configuration of the management application module 21 of FIG. 16, the case is assumed that in the initial state (the state in which the determination application is not registered in the determination application registration module 209), an event other than the install event of a specific application name is not notified to the management application module 21.

Specifically, the configuration of the management application module 21 of FIG. 16 corresponds to a combination of the configuration of FIG. 11 and the configuration of FIG. 13. In the initial state, only the install event of the specific application name is transmitted from the access detection/control module 10 to the management application module 21. Events other than the install event of the specific application name are not transmitted from the access detection/control module 10 to the management application module 21.

Upon receiving the install event of the specific application name from the access detection/control module 10, the application selection module 205 transmits this install event to the signature verification module 206. This specific application name may be prestored in the selection rule management module 203.

Upon receiving the install event of the specific application name, the signature verification module 206 instructs the application acquisition module 208 to acquire an application package file corresponding to the specific application name. Then, based on the certificate (signature) given to the acquired application package file, the signature verification module 206 executes signature verification for confirming the integrity of this application package file (the application of the specific application name). Based on the result of the signature verification, the signature verification module 206 transmits the determination result, which is indicative of permission or prohibition of install of the application of the specific application name, to the access detection/control module 10 via the communication process module 201.

The signature verification module 206 executes not only the signature verification of the application of the specific application name, but also the verification process of the determination application. Specifically, when the registration request has been received from the determination application module 22, the signature verification module 206 instructs the application acquisition module 208 to acquire the application package file of the determination application module 22. Then, based on the certificate (signature) given to the acquired application package file, the signature verification module 206 executes signature verification for confirming the integrity of this application package file. Only when the integrity has been confirmed, the determination application module 22 is registered in the determination application registration module 209.

If the determination application module 22 is registered in the determination application registration module 209, the activate module 212 transmits an activation instruction to the access detection/control module 10 via the communication process module 201, and instructs the access detection/control module 10 to notify all events (including install events of all applications and other various events). Thereby, hereafter, the access detection/control module 10 notifies all events to the management application module 21.

After the access detection/control module 10 is activated, if the management application module 21 receives the install event of the above-described specific application name from the access detection/control module 10, the permission or prohibition of install of the application having this specific application name is determined by the signature verification module 206 in the same manner as in the case of the initial state.

If the event received from the access detection/control module 10 is an install event of an application other than the application having the specific application name or an event other than an install event, the management application module 21 transmits the received event to the determination application module 22.

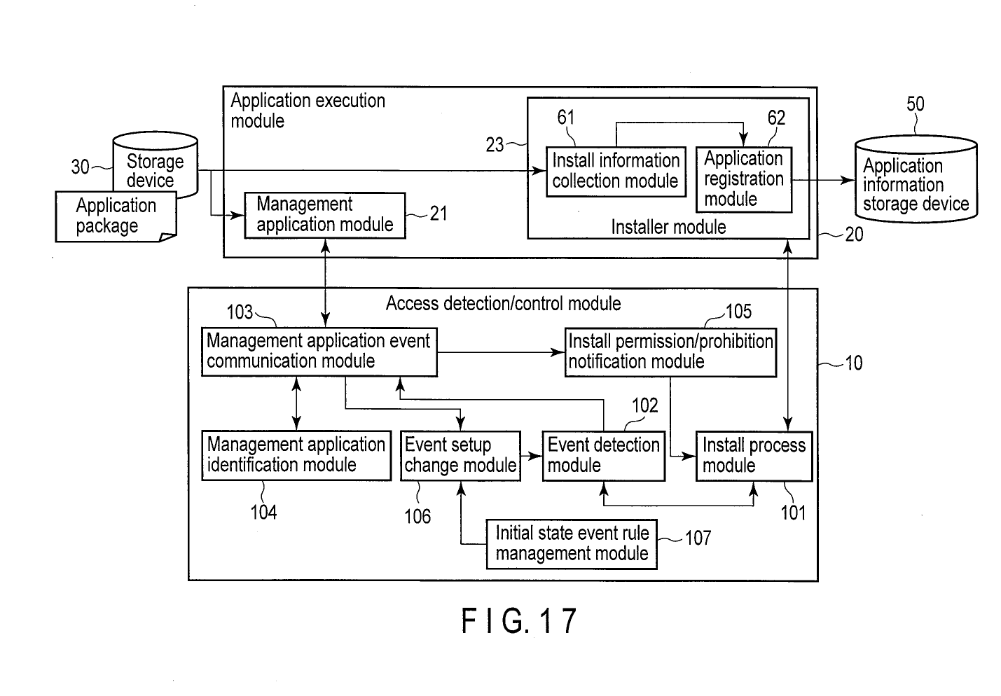

FIG. 17 illustrates a configuration of the access detection/control module 10, which corresponds to the configuration of the management application module 21 of FIG. 16.

As shown in FIG. 17, an initial state event rule management module 107 is added in the access detection/control module 10. This initial state event rule management module 107 stores a specific application name which is notified to the management application module 21 when an install event has occurred, a rule for determining permission or prohibition of an install event of each of application names other than the specific application name, and a rule for determining permission or prohibition of each event other than the install event. In the initial state, that is, while the management application module 21 is not registered in the management application identification module 104 and the management application module 21 is not identified as the counterpart to which event information such as install event information is to be transmitted, permission or prohibition of each of all events is determined based on the rule stored in the initial state event rule management module 107. If the management application module 21 is registered in the management application identification module 104, the rule of the event detection module 102 is updated via the event setup change module 106, and the access detection/control module 10 notifies only the install event of the specific application name to the management application module 21 via the management application event communication module 103. Specifically, the access detection/control module 10 detects an event of requesting install of the application program having the specific application name, and transmits the install event information including this specific application name to the management application module 21, prior to execution of install of the application program having this specific application name.

On the other hand, in the state immediately after the management application module 21 is registered in the management application identification module 104, the permission or prohibition of each install event other than the install event of the specific application name is determined in the access detection/control module 10 according to the rule in the initial state event rule management module 107.

If the activation instruction is received from the management application module 21, the event setup change module 106 changes the event, which is the target of notification, so that all install events are notified to the management application module 21 from the access detection/control module 10.

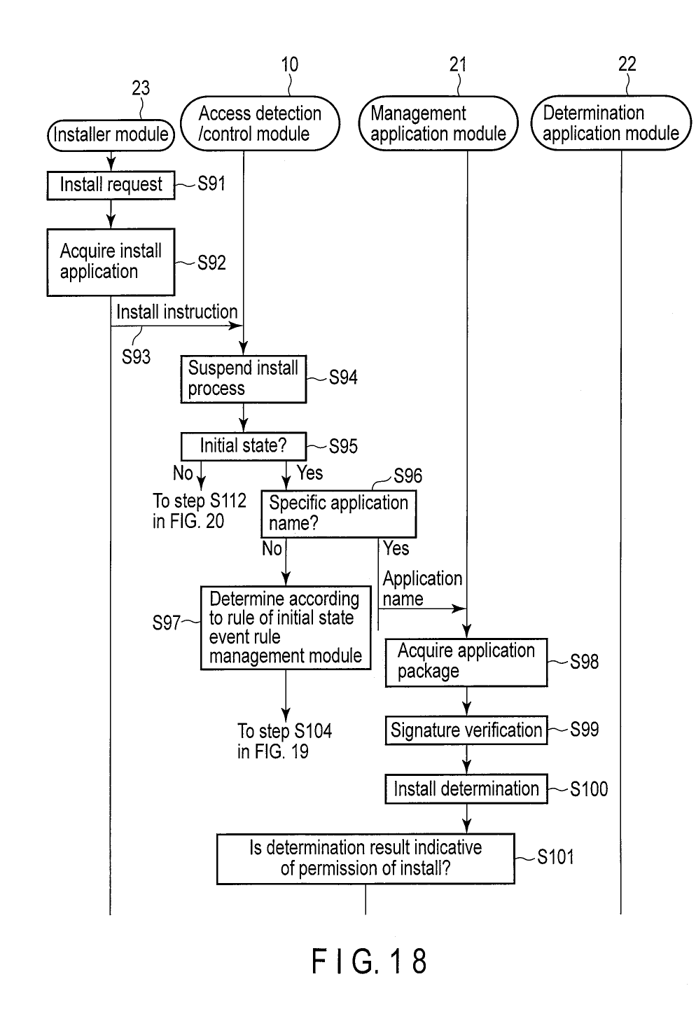

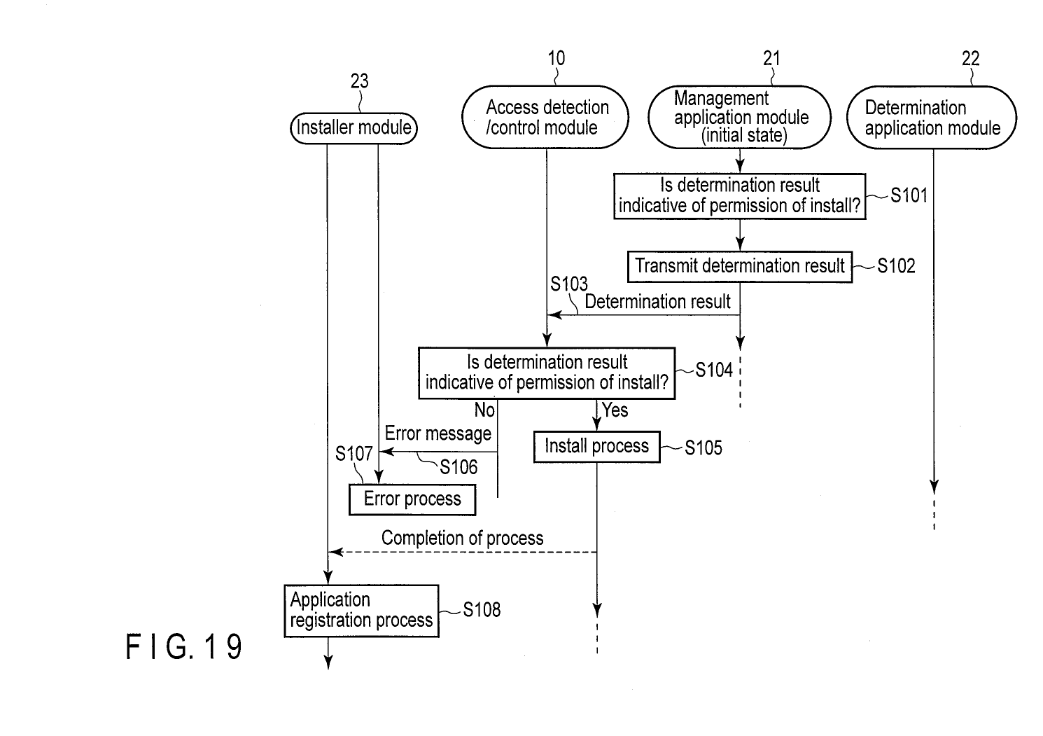

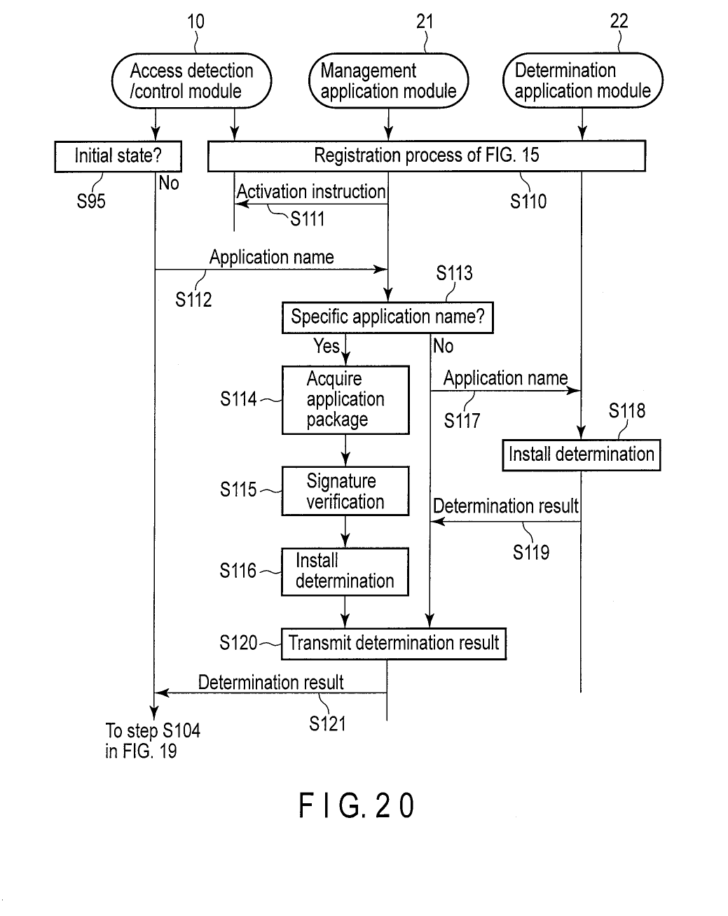

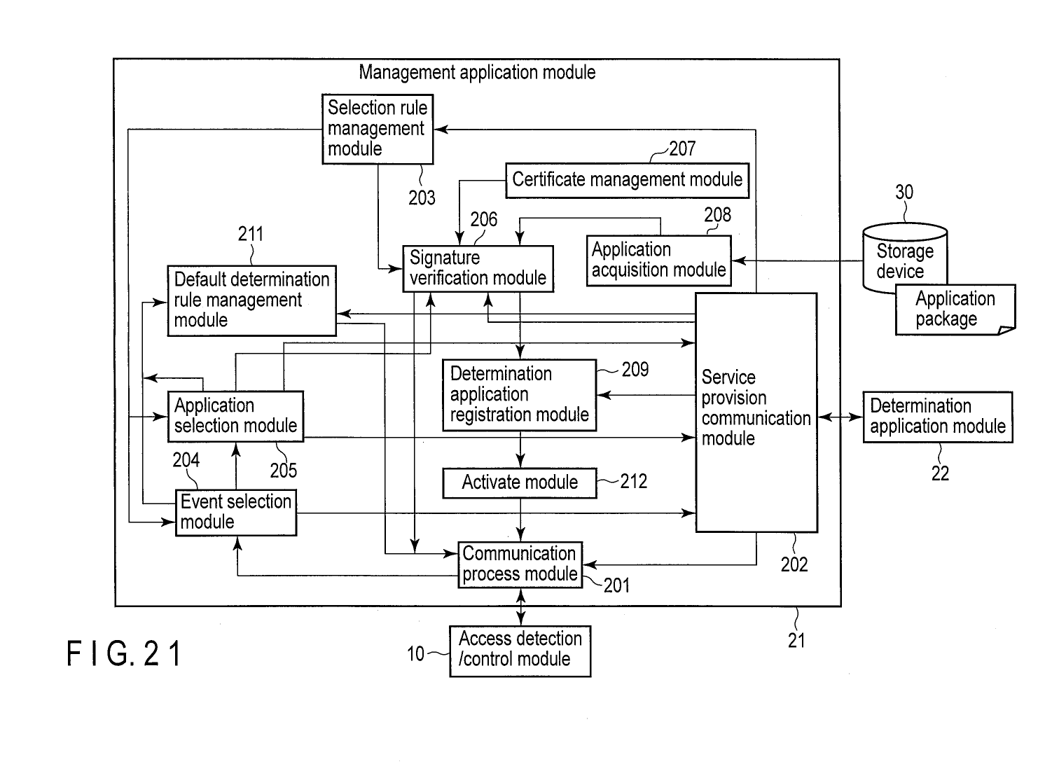

Next, referring to flowcharts of FIG. 18, FIG. 19 and FIG. 20, a description is given of the procedure of the process which is executed by the installer module 23, access detection/control module 10, management application module 21 and determination application module 22.

If an install request occurs in accordance with an application install operation by the user (step S91), the installer module 23 acquires an application package file corresponding to an application that is an install target (step S92). Then, the installer module 23 transmits an install instruction for install of the install-target application to the access detection/control module 10 (step S93).

Upon receiving the install instruction, the access detection/control module 10 detects the occurrence of an event of requesting install of the application. The access detection/control module 10 suspends the execution of the install process (step S94).

The access detection/control module 10 determines whether the access detection/control module 10 is in an inactivated state (initial state) or not (step S95). If the access detection/control module 10 is in the inactivated state (initial state), the access detection/control module 10 determines whether the application, which is to be installed by the installer module 23, is the application having the above-described specific application name (step S96).

If the application, which is to be installed by the installer module 23, is not the application having the above-described specific application name, the access detection/control module 10 determines permission/prohibition of the install event, according to the rule stored in the initial state event rule management module 107 (step S97).

On the other hand, if the application, which is to be installed, is the application having the above-described specific application name, the access detection/control module 10 transmits the install event and the above-described specific application name as the install event information to the management application module 21.

The management application module 21 acquires an application package file corresponding to the application name included in the install event information which is received from the access detection/control module 10 (step S98), and executes signature verification for confirming the integrity of the application that is to be installed by the installer module 23, by using the certificate (signature) given to the application package file and the public key corresponding to the certificate (signature) (step S99). Then, the management application module 21 confirms the result of the signature verification (step S100), and determines whether or not to permit install, in accordance with the result of the signature verification (step S101).

Then, as illustrated in FIG. 19, the management application module 21 transmits the determination result to the access detection/control module 10 (step S102). The determination result is transmitted to the access detection/control module 10 via the communication process module 201 in the management application module 21 (step S103).

The access detection/control module 10 determines whether the determination result (the determination result based on the rule stored in the initial state event rule management module 107, or the determination result received from the management application module 21) is indicative of permission of install (step S104). If the determination result is indicative of prohibition of install (No in step S104), the access detection/control module 10 returns an error message to the installer module 23, without executing the install process of the install-target application (step S106). The installer module 23 executes an error process, such as notifying the user of the error of install (step S107).

On the other hand, if the determination result is indicative of permission of install (Yes in step S104), the access detection/control module 10 executes the install process for installing the install-target application (step S105). In the install process, for example, a file corresponding to the application package file is created at a predetermined directory. Then, if the install process is completed, the installer module 23 registers, for instance, a thumbnail image file in the application package file in the application information storage device 50 (step S108).

As illustrated in FIG. 20, if the determination application module 22 is installed, a registration process for registering the determination application module 22 in the management application module 21 is started (step S110). In step S110, the process described in FIG. 15 is executed.

The management application module 21 transmits an activation instruction to the access detection/control module 10 (step S111).

When the access detection/control module 10 is in the activated state, that is, when the access detection/control module 10 is not in the initial state (No in step S95), the access detection/control module 10 transmits all of the events that have occurred to the management application module 21. For example, if an install event of a certain application has occurred, the access detection/control module 10 transmits the install event and the application name of the application, which is to be installed, to the management application module 21 as the install event information (step S112).

The management application module 21 determines whether the application name (the application to be installed by the installer module 23) included in the install event information, which is received from the access detection/control module 10, is the specific application name (step S113).

If the application, which is to be installed by the installer module 23, is the specific application name (Yes in step S113), the management application module 21 acquires an application package file corresponding to the specific application name (step S114), and executes signature verification for confirming the authenticity of the application that is to be installed by the installer module 23, by using the certificate (signature) given to the application package file and the public key corresponding to the certificate (signature) (step S115). Then, the management application module 21 confirms the result of the signature verification, and determines whether or not to permit install, in accordance with the result of the signature verification (step S116).

On the other hand, if the application, which is to be installed by the installer module 23, is not the specific application name (No in step S113), the management application module 21 notifies the install event information to the determination application module 22 (step S117). Based on the application name included in the install event information, the determination application module 22 determines permission or prohibition of install of the application (step S118). The management application module 21 receives the determination result indicative of permission or prohibition of install from the determination application module 22 (step S119).

The management application module 21 transmits to the access detection/control module 10 the determination result by the signature verification module 206 in the management application module 21, or the determination result by the determination application module 22 (step S120). The determination result is transmitted to the access detection/control module 10 via the communication process module 201 in the management application module 21 (step S121). Then, the access detection/control module 10 executes the process of step S104 onwards in FIG. 19.

FIG. 21 illustrates another configuration of the management application module 21. In this management application module 21, a default determination rule management module 211 is added to the configuration of FIG. 16.

In the configuration of FIG. 9, when the management application module 21 is unable to communicate with the determination application module 22 because of some cause, or when the determination application module 22 is not registered in the determination application registration module 209 of the management application module 21, the default determination rule management module 211 transmits a determination result indicative of permission or prohibition of install to the access detection/control module 10 via the communication process module 201. The management application module 21 of FIG. 21 is configured such that the permission or prohibition of all events including an install event is determined by the default determination rule management module 211 of the management application module 21, until an event registration request is received from the determination application module 22, not only in the case where the condition described in FIG. 9 is established, but also even in the case where the management application module 21 is in the state in which management application module 21 is communicable with the determination application module 22 and the determination application module 22 is registered in the determination application registration module 209 of the management application module 21.

Specifically, if the determination application module 22 is registered in the determination application registration module 209, the activate module 212 transmits an activation instruction to the access detection/control module 10 via the communication process module 201. Thereby, hereafter, the access detection/control module 10 notifies all events to the management application module 21. However, even if the determination application module 22 is registered in the determination application registration module 209, all events are processed by the management application module 21 until the event registration request is transmitted from the determination application module 22 to the management application module 21. In this case, the event selection module 204 and application selection module 205 notify, according to the rule of the selection rule management module 203, the default rule determination module 211 of each of events other than the install event of the above-described specific application name. The permission/prohibition of execution of each of the events other than the install event of the specific application name is determined by the default rule determination module 211 according to the determination rule stored in the default rule determination module 211, and the determination result is transmitted to the access detection/control module 10 via the communication process module 201.

If the service provision communication module 202 receives the event registration request from the determination application module 22, the service provision communication module 202 updates the rule of the selection rule management module 203 in accordance with the event registration request. Thereby, hereafter, each event, which is designated by the event registration request, is transmitted to the determination application module 22. Specifically, the event selection module 204 and application selection module 205 determine, according to the rule of the selection rule management module 203, whether the received event is an event which is to be transmitted to the determination application module 22. If the received event is the event which is to be transmitted to the determination application module 22, the received event is transmitted to the determination application module 22 via the service provision communication module 202. On the other hand, if the received event is not the event which is to be transmitted to the determination application module 22, the received event is transmitted to the default determination rule management module 211.

The configuration of the management application module 21 of FIG. 21 is particularly useful when one terminal is used both for business use and for consumer use. In general, in the consumer use, there is no need to restrict the execution of an event which is detected by the event detection module 102 of the access detection/control module 10, such as install or activation of an application. At this time, if the determination application module 22 is not installed, the determination application module 22 does not transmit the registration request to the management application module 21, and the management application module 21 does not transmit the activation instruction to the access detection/control module 10, and as a result the permission/prohibition of the event is determined according to the initial rule of the event setup change module 106. At this time, it should suffice if a rule which does not impose restriction (prohibition) is set in the event setup change module 106. Thereby, in the case of use by general consumers, the event detected in the event detection module 102 is not particularly restricted. On the other hand, in the case where the information processing apparatus 1 is used for business work in a company, it is necessary to impose various restrictions on the terminal according to the security policy of the administrator. In this case, the determination application module 22 including a determination rule according to the security policy of each company is installed. If the determination application module 22 transmits a registration request to the management application module 21 and the management application module 21 transmits an activation instruction to the access detection/control module 10, an event which is detected hereafter by the event detection module 102 is transmitted to the management application module 21. If the determination application module 22 transmits an event registration request to the management application module 21, each event, which is transmitted from the access detection/control module 10, is transmitted to the determination application module 22 via the management application module 21, and the permission/prohibition of each event is determined based on the determination rule according to the security policy of each company.

Furthermore, the determination application module 22 can designate an event, the notification of which is to be requested, to the management application module 21 by using the above-described event registration request. Thus, the determination application module 22 can receive only an event, the notification of which is to be requested, from the management application module 21. Thus, since an event, which does not need to be particularly restricted, is processed by the default rule determination module 211 of the management application module 21, no communication is needed between the management application module 21 and determination application module 22, thereby enabling quick determination and enhancing the processing speed of the apparatus. The determination application module 22 can notify the management application module 21 of the event that is to be received, by the above-described event registration request.

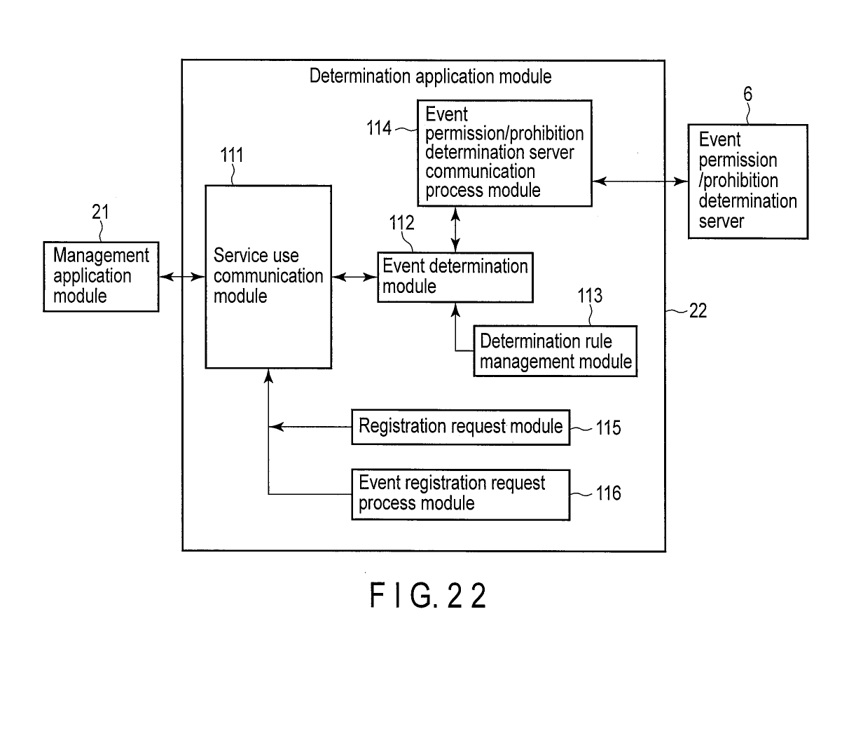

FIG. 22 illustrates a configuration of the determination application module 22 to which an event registration request process module 116 is added. The event registration request process module 116 transmits an event registration request, which is indicative of each event that is to be received, to the management application module 21 via the service use communication module 111.

The event registration request is a request for asking the management application module 21 to give notification of each of event, for instance, a “request asking notification of an install event”, a “request asking notification of an uninstall event”, a “request asking notification of a WiFi® connection event”, a “request asking notification of an SD card connection event”, or a “request asking notification of a USB memory connection event”. Incidentally, the event registration request may be a request asking notification of all events.

In addition, even if the management application module 21 receives from the determination application module 22 an event registration request asking notification of all events, the management application module 21 does not notify the determination application module 22 of an install event having a specific application name.

Besides, such an instruction as to update the determination rule of the default determination rule management module 211 may be included in the event registration request of the determination application module 22. As described above, the determination rule of the default determination rule management module 211 of the management application module 21 is used both in the state that the determination application module 22 is not registered in the determination application registration module 209 and in the state that the management application module 21 has become unable to communicate with the determination application registration module 209 because of some cause after the determination application module 22 was registered in the determination application registration module 209. The instruction as to update the determination rule of the default determination rule management module 211 can change the determination rule under these two states. For example, in the state in which the determination application module 22 is not registered in the determination application registration module 209, events are not restricted (uninstall, WiFi® connection, SD card connection, or USB memory connection is permitted) since the information processing apparatus 1 is used for general consumers. However, after the determination application module 22 is registered in the determination application registration module 209, since the information processing apparatus 1 is used for business purposes, the determination rule may be changed to restrict events when the management application module 21 has become unable to communicate with the determination application registration module 209 for some reason.

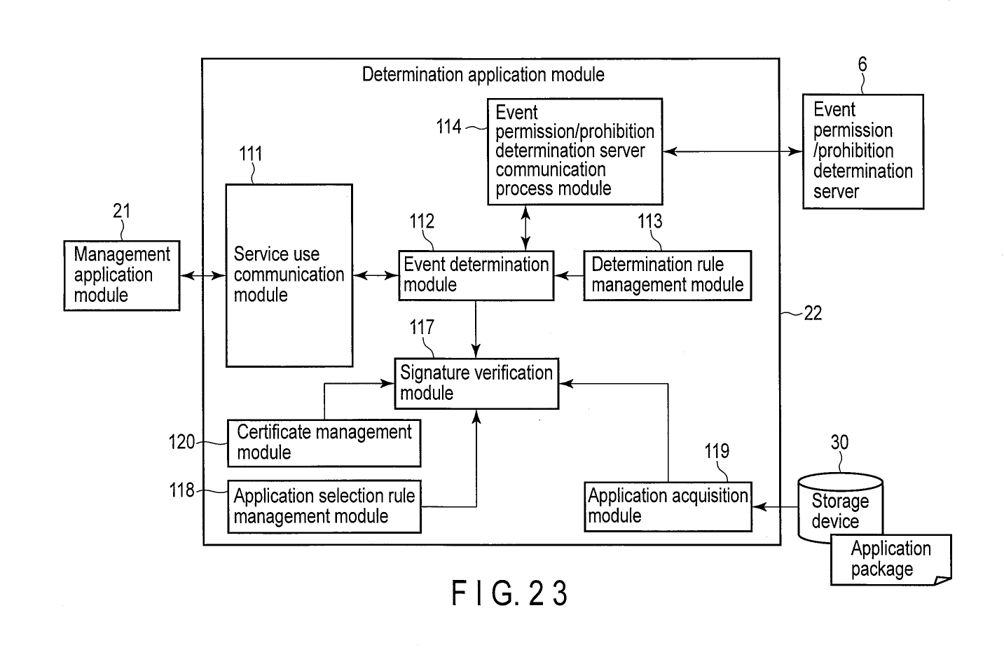

FIG. 23 illustrates a configuration of the determination application module 22 in which a signature verification module 117 is added.

The determination application module 22 of FIG. 23 does not determine permission or prohibition of install of an application, based on only the application name included in the event information, but executes, where necessary, signature verification of the application that is the install target.

The determination application module 22 receives notification of event information (install event and application name) from the management application module 21. If the event determination module 112 detects that the notified event information is an install event, the event determination module 112 notifies the signature verification module 117 of the application name of the application that is to be installed. Based on the application selection rule stored in an application selection rule management module 118, the signature verification module 117 determines whether the application that is to be installed is an application that is a target of signature verification.

If the application that is to be installed is the application that is the target of signature verification, the signature verification module 117 instructs an application acquisition module 119 to acquire an application package file of this application from the storage device 30, and verifies whether the signature included in the application package file agrees with the value of the signature which is managed in a certificate management module 120. If these agree, the determination application module 22 notifies the management application module 21 of the determination result indicative of permission of install. On the other hand, if these do not agree, the determination application module 22 determines that the application that is to be installed is a false application having the same name as the authenticated application, and notifies the management application module 21 of the determination result indicative of prohibition of install.

In the meantime, the signature verification module 117 may be added to the configuration of the determination application module 22 of FIG. 22.

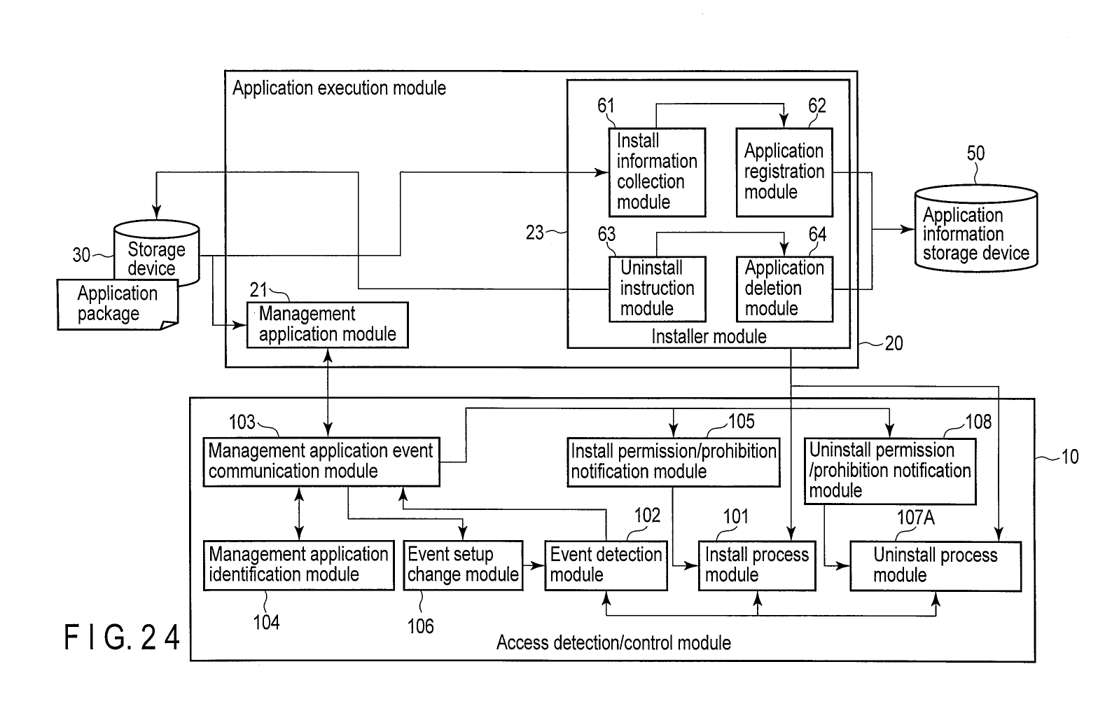

FIG. 24 illustrates other configurations of the access detection/control module 10 and the application execution module 20. In this example, the case is assumed that not only install restriction but also uninstall restriction is executed.

In the case of using the information processing apparatus 1 for business work in the company, it is possible that various business applications are installed in the information processing apparatus 1. The kinds of business applications vary from company to company. In addition, the determination application module 22 is prepared for each company. Thus, install of such business applications is basically permitted by the determination application module 22. Further, business applications may include, in some cases, an application for monitoring behaviors of workers, such as monitoring a connection access point name of a terminal, thereby to confirm whether the terminal is brought to another network, or monitoring the position of the terminal at all times by a GPS. The user may delete such a monitoring application. The uninstall restriction function of this embodiment is used to restrict uninstall of such business applications.

As shown in FIG. 24, in the installer module 23, an uninstall instruction module 63 and an application deletion module 64 are added. The uninstall instruction module 63 instructs the application deletion module 64 to uninstall of an application in accordance with a user operation, and instructs the application execution module 20 to start uninstall. The application deletion module 64 deletes from the application information storage device 50, for example, a thumbnail image file corresponding to the application that is the uninstall target.

In the access detection/control module 10, an uninstall process module 107A and an uninstall permission/prohibition notification module 108 are added.

Upon receiving an uninstall start instruction (uninstall request) from the installer module 23, the uninstall process module 107A causes the installer module 23 to wait for execution of an uninstall process. The occurrence of the uninstall request is detected as an uninstall event by the event detection module 102. The management application event communication module 103 notifies the management application module 21 of the uninstall event and the event information (uninstall event information) including the application name of the uninstall target.

Upon receiving a determination result, which is indicative of permission or prohibition of uninstall, from the management application module 21, the management application event communication module 103 outputs the received determination result to the uninstall permission/prohibition notification module 108. The uninstall permission/prohibition notification module 108 controls the operation of the uninstall process module 107A, based on the content of the determination result. If the determination result is indicative of permission of uninstall, the uninstall process module 107A, in cooperation with the installer module 23, executes the uninstall process. On the other hand, if the determination result is indicative of prohibition of uninstall, the uninstall process module 107A does not execute the uninstall process. Thereby, the execution of uninstall, which has been requested by the user, is prohibited.

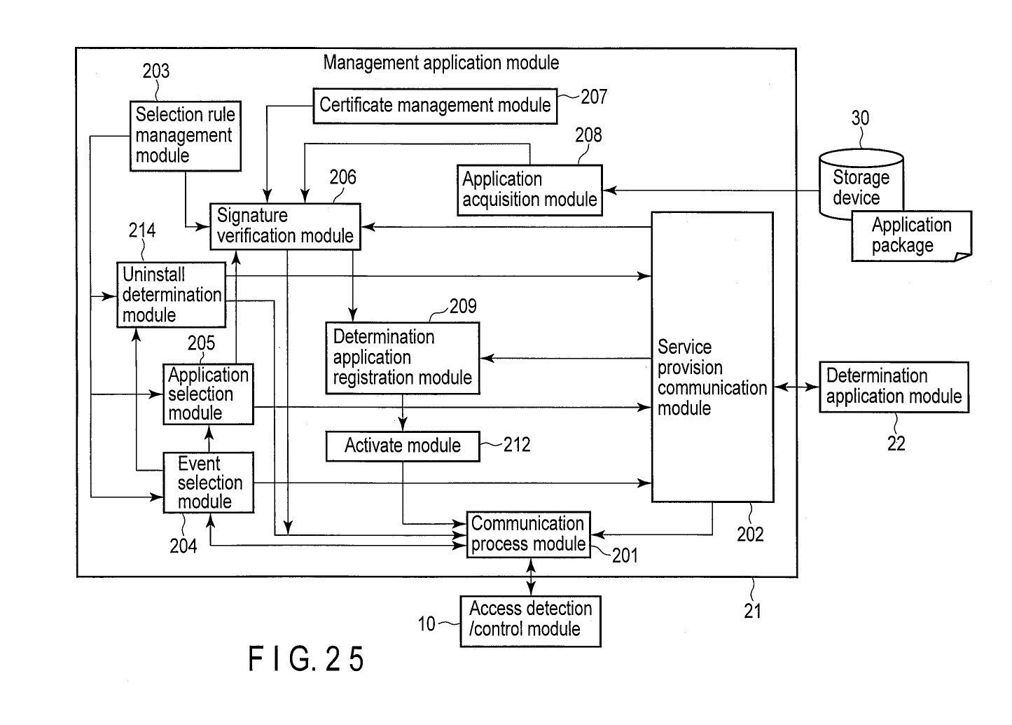

FIG. 25 illustrates a configuration of the management application module 21 including an uninstall determination function. In the management application module 21 of FIG. 25, an uninstall determination module 214 is added to the configuration of the management application module 21 which has been described in FIG. 16.

The activate module 212 instructs the access detection/control module 10 in advance as to whether an uninstall event is to be transmitted to the management application module 21 in the initial state (the state in which the determination application is not registered in the determination application registration module 209). The access detection/control module 10 can detect, for example, an install event, an uninstall event, and a connection request event. If an uninstall event has been detected, the access detection/control module 10 transmits the uninstall event and the application name to the management application module 21 as event information (uninstall event information).

In the management application module 21, all event information, which has been received from the access detection/control module 10, is sent to the event selection module 204. The event selection module 204 determines, in addition to the condition illustrated in FIG. 16, whether the received event information is an uninstall event or an event (install event, connection request event, etc.) other than the uninstall event. If the received event information is an uninstall event, the received event information is sent to the uninstall determination module 214. On the other hand, if the received event information is neither an uninstall event nor an install event of a specific application name, the received event information is notified to the determination application module 22 via the service provision communication module 202.

In the selection rule management module 203, the application name of the management application module 21 is prestored as an application name of an application, the uninstall of which is to be prohibited. The uninstall determination module 214 determines whether the uninstall-target application name included in the event information, which is received from the event selection module 204, agrees with the application name of the management application module 21. If the uninstall-target application name agrees with the application name of the management application module 21, the uninstall determination module 214 transmits a determination result indicative of prohibition of uninstall to the access detection/control module 10 via the communication process module 201. Thereby, it is possible to prevent the management application module 21 itself from being uninstalled.

On the other hand, if the uninstall-target application name included in the event information, which is received from the event selection module 204, does not agree with the application name of the management application module 21, the uninstall determination module 214 notifies this event information to the determination application module 22 via the service provision communication module 202.

In the meantime, if the uninstall-target application name included in the event information, which is received from the event selection module 204, does not agree with the application name of the management application module 21, the uninstall determination module 214 may transmit a determination result indicative of permission of uninstall to the access detection/control module 10 via the communication process module 201, instead of notifying this event information to the determination application module 22.

In addition, the above-described uninstall determination module 214 may be added to the configuration of the management application module 21 which has been described with reference to FIG. 21.

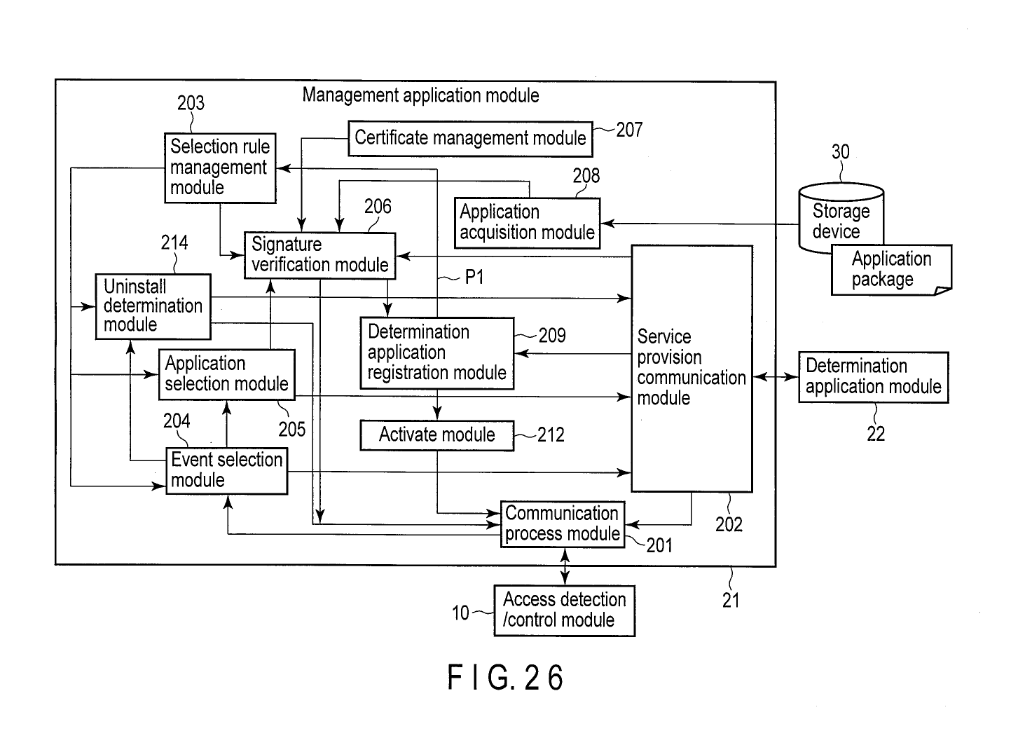

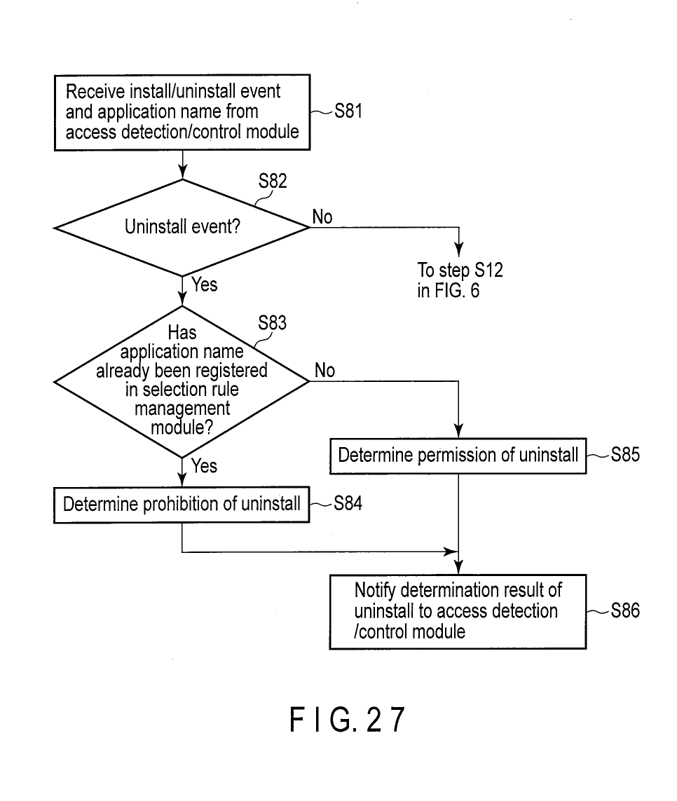

FIG. 26 illustrates another configuration of the management application module 21 including the uninstall determination function. In the management application module 21 of FIG. 26, a path P1 from the determination application registration module 209 to the selection rule management module 203 is added to the configuration of the management application module 21 which has been described in FIG. 25. The path P1 is used for registering the application name of the determination application, whose integrity has been confirmed, in the selection rule management module 203 as the application name of the application, the uninstall of which is to be prohibited.

Upon receiving event information from the event selection module 204, the uninstall determination module 214 determines whether the application name of the uninstall target included in this event information agrees with any one of application names registered in the selection rule management module 203. If the application name of the uninstall target agrees with any one of application names registered in the selection rule management module 203, the uninstall determination module 214 transmits the determination result indicative of prohibition of uninstall to the access detection/control module 10 via the communication process module 201. In the selection rule management module 203, the application name of the management application module 21 and the application name of the determination application module 22 are registered. Thus, when the uninstall-target application name agrees with either the application name of the management application module 21 or the application name of the determination application module 22, the uninstall is prohibited. Thereby, not only the uninstall of the management application module 21, but also the uninstall of the determination application module 22 can be prevented.

Needless to say, such a configuration may be adopted that only the uninstall of the determination application module 22 is prevented.

On the other hand, if the application name of the uninstall target, which is included in the event information received from the event selection module 204, agrees with none of the application names registered in the selection rule management module 203, the uninstall determination module 214 notifies this event information to the determination application module 22 via the service provision communication module 202.

In the meantime, if the application name of the uninstall target agrees with none of the application names registered in the selection rule management module 203, the uninstall determination module 214 may transmit a determination result indicative of permission of uninstall to the access detection/control module 10 via the communication process module 201, instead of notifying this event information to the determination application module 22.

A flowchart of FIG. 27 illustrates the procedure of a process which is executed by the management application module 21 of FIG. 25 or FIG. 26.

The management application module 21 receives an install/uninstall event and an application name from the access detection/control module 10 (step S81). The management application module 21 determines whether the received event is an uninstall event or not (step S82).

If the received event is an uninstall event (Yes in step S82), the management application module 21 determines whether the application name of the uninstall target is registered in the selection rule management module 203 (step S83). If the application name of the uninstall target is registered in the selection rule management module 203 (Yes in step S83), the management application module 21 determines prohibition of uninstall (step S84). On the other hand, if the application name of the uninstall target is not registered in the selection rule management module 203 (No in step S83), the management application module 21 determines permission of uninstall (step S85).

Then, the management application module 21 notifies the determination result of prohibition/permission of uninstall, which has been determined in step S84 or step S85, to the access detection/control module 10 (step S86).

On the other hand, if the received event is an install event (No in step S82), the management application module 21 goes to the process of step S12 in FIG. 6.

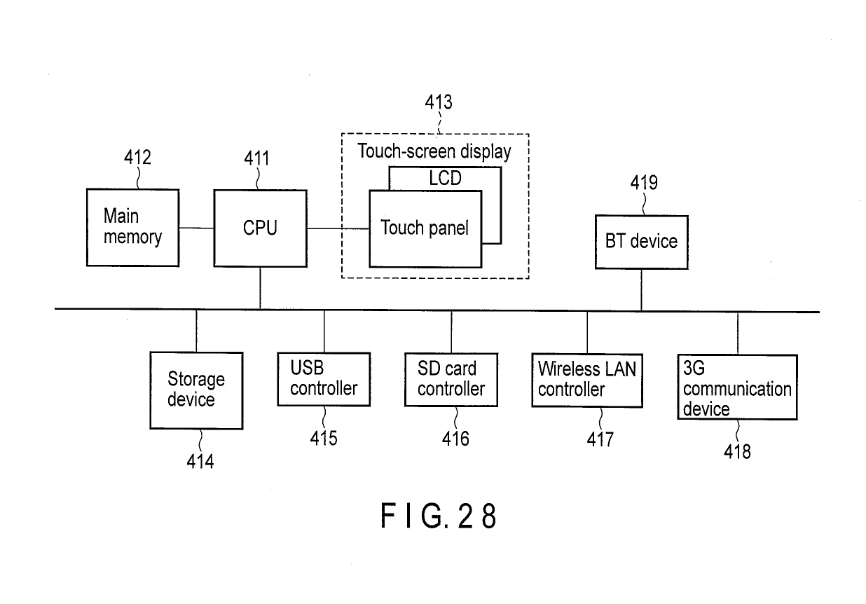

FIG. 28 illustrates a hardware configuration example of the information processing apparatus 1. The information processing apparatus 1 includes a CPU 411, a main memory 412, a touch-screen display 413, a storage device 414, a USB controller 415, an SD card controller 416, a wireless LAN controller 417, a 3G communication device 418, and a Bluetooth® device (BT device) 419.

The CPU 411 is a processor which controls the respective components in the information processing apparatus 1. The CPU 411 executes various kinds of software, which are loaded from the storage device 414 into the main memory 412, for instance, an OS, an application program, etc. The above-described access detection/control module 10 is executed as a part of the OS.

The management application module 21 and determination application module 22 are realized as different application programs, as described above. An application program corresponding to the management application module 21 may be pre-installed in the storage device 414, as described above.

The application program corresponding to the determination application module 22 is, for example, an application program which is prepared for each company, and determines permission or prohibition of execution of an event according to the determination rule which is suited to the corresponding company. Since the determination application module 22 is a module different from the management application module 21, the determination application conforming to the policy of each company can easily be created.

For example, when the information processing apparatus 1 is used in business work in company A, the determination application module 22 for company A and various application programs for company A may be installed in the information processing apparatus 1. The determination application module 22 for company A may include a rule set for permitting install of each of the various application programs for company A and for prohibiting install of other application programs.

In addition, when the information processing apparatus 1 is used in business work of company B, the determination application module 22 for company B and various application programs for company B may be installed in the information processing apparatus 1. The determination application module 22 for company B may include a rule set for permitting install of each of the various application programs for company B and for prohibiting install of other application programs.

The touch-screen display 413 is a display which can detect a touch position on the screen, and includes a flat-panel display such as a liquid crystal display (LCD), and a touch panel.

The USB controller 415 is configured to execute communication with a USB device (e.g. USB memory) which is attached to a USB port provided in the information processing apparatus 1. The SD card controller 416 is configured to execute communication with a memory card (e.g. SD card) which is inserted in a card slot provided in the information processing apparatus 1. The wireless LAN controller 417 is a wireless communication device configured to execute wireless communication according to WiFi®, etc. The 3G communication device 418 is a wireless communication device configured to execute 3G mobile communication. The Bluetooth® device 419 is a wireless communication device configured to execute communication with an external Bluetooth® device.

As has been described above, according to the present embodiment, prior to the execution of install, the install event information including the application name of an application program, which is to be installed, is transmitted from the access detection/control module 10 to the management application module 21. Then, the management application module 21 notifies the install event information to the determination application module 22 that is the determination program, and transmits the determination result indicative of permission or prohibition of install, which is received from the determination application module 22, to the access detection/control module 10.

In this manner, the permission or prohibition of install is determined by the determination program (determination application module 22) which is independent from the management application module 21. Accordingly, for example, by preparing the determination program for each company, the permission/prohibition of install can be determined by using rule sets which are different between companies. Moreover, the rule set can easily be updated by simply updating the determination application module 22. Therefore, by realizing the management application module 21 and the determination application module 22 by independent modules, the content of the install restriction can flexibly be controlled.

In addition, since the environment for install restriction of each application program is provided by the management application module 21, the configuration of the determination application module 22 can be simplified.

Furthermore, since the permission/prohibition of install of an application can be determined before the application is actually installed, an application, the install of which is not permitted, can surely be prevented from being installed.

Since the management application module 21 can be realized by an application program, the update of the management application module 21 itself can easily be executed.

The management application module 21 confirms the integrity of the determination application module 22, based on the signature that is given to the determination application module 22, and when the integrity of the determination application module 22 has been confirmed, the management application module 21 identifies this determination application module 22 as the communication counterpart to which the install event information is to be notified. Therefore, the user of a false determination application can surely be prevented.

Besides, the access detection/control module 10 stores the application name of the management application module 21, and identifies, based on this stored application name, the application corresponding to the management application module 21 as the communication counterpart to which the install event information is to be notified. Except for update of an application, the installer module 23 restricts new install of an application having the same application name as the application that is installed. Therefore, it is possible to surely prevent install information from being sent to a false management application module.

In the present embodiment, the description has been given of the configuration which prevents illegitimate uninstall of the determination application. However, the management application module 21 may have a “mode of permitting uninstall of a determination application”, and uninstall of the determination application may be permitted when the management application module 21 is in this mode. Thereby, the user can uninstall the determination application by a normal procedure.

In addition, in the present embodiment, the description has been given of the case in which the access detection/control module 10 detects the uninstall request from the installer module 23 as the uninstall event. However, the access detection/control module 10 may detect an application deletion instruction to the application information storage device 50 as the uninstall event.

All the procedures of the install restriction process in this embodiment can be executed by software. Thus, the same advantageous effects as with the present embodiment can easily be obtained simply by installing a computer program, which executes these procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a management application module configured to provide an environment for an installation restriction of each of application programs; and
a controller configured to detect a request to install an application program, and to transmit, prior to execution of the installation, installation event information including an application name of the application program to the management application module,
wherein the management application module is configured to notify the installation event information to a determination program, and to transmit to the controller a determination result indicative of permission or prohibition of the installation, the determination result being received from the determination program.

2. The information processing apparatus of claim 1, wherein the controller comprises software in an operating system layer, the management application module comprises a first application program configured to be executed in an application layer, and the determination program configured to be executed in the application layer.

3. The information processing apparatus of claim 1, wherein the management application module comprises a public key storage configured to preserve a public key for verifying a certificate which is given to the determination program, and
the management application module is further configured to confirm integrity of the determination program, based on the certificate which is given to the determination program, and to identify, when the integrity of the determination program is confirmed, the determination program as a communication counterpart to which the installation event information is to be notified.

4. The information processing apparatus of claim 1, wherein a signal system call is configured to be used for communication between the management application module and the controller, and inter-process communication is configured to be used for communication between the management application module and the determination program.

5. The information processing apparatus of claim 1, wherein the controller comprises software in an operating system layer, and the management application module comprises a first application program configured to be executed in an application layer, and
the controller is further configured to store an application name of the first application program, and to identify, based on the stored application name, the first application program as a communication counterpart to which the installation event information is to be transmitted.

6. The information processing apparatus of claim 1, wherein the management application module is further configured to confirm, after the determination program is installed in the information processing apparatus, integrity of the determination program, based on a request of the determination program, and to instruct, when the integrity of the determination program has been confirmed, the controller to transmit the installation event information in response to detection of the event.

7. The information processing apparatus of claim 1, wherein the controller includes a determination rule for determining permission/prohibition of execution of an event other than the installation event, and is configured to determine, before receiving a predetermined instruction from the management application module, the permission/prohibition of execution of the event other than the installation event according to the determination rule, and
the controller is further configured to update the determination rule, based on the predetermined instruction, to inquire the management application module about the permission/prohibition of execution of the event other than the installation event, to receive from the management application module a determination result indicative of permission or prohibition of the execution of the event other than the installation event, and to determine, based on the received determination result, whether to execute the event other than the installation event.

8. The information processing apparatus of claim 1, wherein the controller is further configured to detect, before receiving a predetermined instruction from the management application module, an event of requesting installation of an application program having a specific application name, to transmit, prior to executing the installation of the application program having the specific application name, installation event information including the specific application name to the management application module, to receive from the management application module a determination result indicative of permission or prohibition of the installation of the application program having the specific application name, and to determine, based on the received determination result, whether to execute the installation of the application program having the specific application name.

9. The information processing apparatus of claim 1, wherein the determination program is configured to determine, based on a predetermined determination rule, permission or prohibition of installation of an application program corresponding to an application name included in the installation event information.

10. The information processing apparatus of claim 1, wherein the controller is further configured to detect an event of requesting uninstallation of an application program, and to transmit, prior to execution of the uninstallation, uninstallation event information including an application name of an application program, which is an uninstallation target, to the management application module, and
the management application module is further configured to transmit a determination result indicative of prohibition of the uninstallation to the controller when the application name of the uninstallation target in the uninstallation event information agrees with an application name of the determination program.

11. The information processing apparatus of claim 1, wherein the controller comprises a software in an operating system layer, the management application module comprises a first application program configured to be executed in an application layer, and the determination program configured to be executed in the application layer,
the controller is further configured to detect an event of requesting uninstallation of an application program, and to transmit, prior to execution of the uninstallation, uninstallation event information including an application name of an application program, which is an uninstallation target, to the management application module, and
the management module is further configured to transmit a determination result indicative of prohibition of the uninstallation to the controller when the application name of the uninstallation target in the uninstallation event information agrees with either an application name of the first application program or an application name of the determination program.

12. The information processing apparatus of claim 11, wherein the management application module is further configured to transmit the uninstallation event information to the determination program when the application name of the uninstallation target in the uninstallation event information agrees with neither the application name of the first application program nor the application name of the determination program, to receive a determination result from the determination program, and to transmit the determination result to the controller.

13. The information processing apparatus of claim 1, wherein the management application module is further configured to determine, when communication with the determination program is not executable, permission or prohibition of uninstallation of an application program corresponding to an application name included in the installation event information, based on a predetermined determination rule which is stored in the management application module.

14. A control method for restricting installation of an application in an information processing apparatus, comprising:
detecting an event of requesting installation of an application program;
transmitting, prior to execution of the installation, installation event information including an application name of the application program to a management application module configured to provide an environment for installation restriction of each of application programs;
notifying the installation event information from the management application module to a determination program; and
executing an installation process for installing the application program, when a determination result which is received from the determination program is indicative of permission of the installation of the application program.

15. The control method of claim 14, wherein said detecting the event and said transmitting the installation event information to the management application module are configured to be executed by software in an operating system layer, and
the management application module comprises a first application program configured to be executed in an application layer, and the determination program configured to be executed in the application layer.

16. The control method of claim 14, further comprising:
confirming integrity of the determination program, based on a certificate which is given to the determination program; and
identifying, when the integrity of the determination program is confirmed, the determination program as a communication counterpart to which the installation event information is to be notified.

17. The control method of claim 14, wherein said detecting the event and said transmitting the installation event information to the management application module are configured to be executed by software in an operating system layer, and the management application module comprises a first application program configured to be executed in an application layer,
the software is configured to store a program name of the first application program, and
the control method further comprises identifying, based on the stored program name, the first application program as a communication counterpart to which the installation event information is configured to be transmitted.

18. A computer-readable, non-transitory storage medium having stored thereon a computer program which is executable by a computer, the computer program controlling the computer to execute functions of:
detecting an event of requesting installation of an application program;
transmitting, prior to execution of the installation, installation event information including an application name of the application program to a management application module configured to provide an environment for installation restriction of each of application programs;
notifying the installation event information from the management application module to a determination program; and
executing an installation process for installing the application program, when a determination result which is received from the determination program is indicative of permission of the installation of the application program.
